(19) United States
(12) Patent Application Publication
(10) Pub. No.: US 2023/0401937 A1
(43) Pub. Date: Dec. 14, 2023

(54) FRAUD AND THEFT DETECTION AND PREVENTION SYSTEMS FOR AUTOMATIC RETAIL AND POINT OF SALE TRANSACTIONS

(71) Applicant: ViaTouch Media Inc., San Diego, CA (US)

(72) Inventors: Thomas Murn, Nissequeogue, NY (US); Preetham Rajkumar, San Diego, CA (US); Milan Alvarado, Corona, CA (US)

(21) Appl. No.: 18/032,324

(22) PCT Filed: Oct. 15, 2021
(86) PCT No.: PCT/US2021/055260

§ 371 Date: Apr. 17, 2023

Related U.S. Application Data
(60) Provisional application No. 63/171,958, filed on Apr. 7, 2021.
(60) Provisional application No. 63/137,480, filed on Jan. 14, 2021.
(60) Provisional application No. 63/092,843, filed on Oct. 16, 2020.

(51) Int. Cl. G07G 3/00; G06Q 20/18; G06Q 20/40; G06Q 20/20; G06Q 20/32; G07G 1/00; G06N 3/045

(52) U.S. Cl. CPC G07G 3/003; G06Q 20/18; G06Q 20/40145; G06Q 20/4016; G06Q 20/208; G06Q 20/3276; G07G 1/0009; G06N 3/045

(57) ABSTRACT

An automatic retail device including a housing including an enclosure having a plurality of shelves mounted in the enclosure, and a door providing access to the enclosure when open and preventing access to the enclosure when closed, a first camera mounted along a top portion of the enclosure and configured to capture images in a top-down manner, a second camera mounted on a side of the enclosure and configured to capture images from of the automatic retail device, and an application stored in a memory to detect a presence of a user's hands in the images generated by the first and second camera, detect a presence of a product in the user's hands in the images, determines an identity and number or products removed from the automatic retail device, and charges the user based on the identity and number of products removed from the automatic retail device.

### CROSS-REFERENCE TO RELATED APPLICATIONS

This application claims priority to U.S. Provisional Application No. 63/092,843 entitled COMPUTER VISION, FRAUD PROTECTION AND SANITIZATION SYSTEMS filed Oct. 16, 2020, U.S. Provisional Application No. 63/137,480 entitled FACIAL RECOGNITION AND BIOMETRIC PAYMENTS filed Jan. 14, 2021, and U.S. Provisional Application 63/171,958 entitled FACIAL RECOGNITION AND SECURITY DEVICE filed Apr. 7, 2021, the entire contents of each of which are incorporated herein by reference.

### BACKGROUND

This disclosure is directed to systems and method for visually monitoring actions at an automated retail device or a point-of-sale terminal. Further the systems and methods described herein are directed to a method of fraud detection and prevention.

### DESCRIPTION OF RELATED ART

Automatic retail devices have been described in a number of commonly owned or licensed patents and applications including, for example, U.S. Pat. No. 8,191,779, entitled WIRELESS MANAGEMENT OF REMOTE VENDING MACHINES; U.S. Pat. No. 8,998,082, entitled MULTIMEDIA SYSTEM AND METHODS FOR CONTROLLING VENDING MACHINES; U.S. Patent Application Publication No. 2015/0279147, entitled, SYSTEMS AND METHODS FOR AUTOMATED DISPENSING SYSTEMS IN RETAIL LOCATIONS, filed Mar. 31, 2015; U.S. Patent Application Publication No. 2017/0148005, entitled INTEGRATED AUTOMATIC RETAIL SYSTEM AND METHOD, filed Nov. 20, 2015 and US Patent Application Publication No. 202000273011, filed Dec. 13, 2017 and entitled METHODS AND UTILITIES FOR CONSUMER INTERACTION WITH A SELF SERVICE SYSTEM. Each of these patents and U.S. Publications are incorporated herein by reference.

Each of these automatic retail devices provide iterative improvements over prior known solutions enabling automatic payment, automatic detection of item removal, and theft detection. However, as is known in other areas, no matter how smart and intelligent the system, a determined person is often capable of subverting these systems. The result is the owner or operator of the automatic retail device suffers losses in both merchandise and sales. While some of these lost sales may be made whole by credit card companies or via insurance policies, the underlying crime is left unpunished, and often unreported. Moreover, seeking recovery via either mechanism remains cumbersome and time consuming. This disclosure is directed to is directed to systems and methods of detecting and preventing fraud and both product and sales losses.

### SUMMARY

One aspect of the disclosure is directed to an automatic retail device, the automatic retail device also includes a housing including an enclosure having a plurality of shelves mounted in the enclosure, and a door providing access to the enclosure when open and preventing access to the enclosure when closed; a first camera mounted along a top portion of the enclosure and configured to capture images in a top-down manner; a second camera mounted on a side of the enclosure and configured to capture images from of the automatic retail device; and an application stored in a memory and executed by a processor, where the application when executed by the processor: detect a presence of a user's hands in the images generated by the first and second camera; detect a presence of a product in the user's hands in the images generated by the first and second camera; determines a identity and number or products removed from the automatic retail device; and charges the user based on the identity and number of products removed from the automatic retail device. Other embodiments of this aspect include corresponding computer systems, apparatus, and computer programs recorded on one or more computer storage devices, each configured to perform the actions of the methods and systems described herein.

Implementations of this aspect of the disclosure may include one or more of the following features. The automatic retail device where the application employs a first convolutional neural network to identify the user's hands and a second convolution neural network to identify a product in the user's hands. The second convolutional neural network analyses a subregion of the image in which the hands are detected. The automatic retail device further including a third convolution neural network configured to determine the identity of the product detected in the user's hands. The application is configured to track the user's hands in the images from the first and second cameras and detect suspicious movements of the user's hands. The automatic retail device further including a fourth convolutional neural network to detect suspicious movement of the user's hands. The weight sensor is configured to detect the removal or return of a product to or from one of the plurality of shelves. The automatic retail device further including a planogram is stored in the memory, the planogram identifying the identity and. The automatic retail device further including a third camera on an interior surface of the door. The application is configured to acquire an image from the third camera, the image including the plurality of shelves and any products on the plurality of shelves. The application identifies the products located on the shelves in the images generated by the third camera. The application identifies portions of the plurality of shelves having no products. The automatic retail device further including an automatic door opener, and configured to open the door without requiring contact from a user. An application on the user's smartphone is in communication with the automatic retail device. The automatic retail device further including a fourth camera on an exterior of the automatic retail device and configured to capture images of an area in proximity to the automatic retail device. The application analyzes images captured by the fourth camera to detect an identity of a person captured in the image is an authorized user. If the person captured in the image is an authorized user, the application unlocks the door. If the person captured in the image has previously committed credit card fraud or theft at an automatic retail device access to the automatic retail device is denied. The automatic retail device further including a convolution neural network to analyze the images acquired to identify the person captured in the image. Implementations of the described techniques may include hardware, a method or process, or computer software on a computer-accessible medium, including software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

### BRIEF DESCRIPTION OF THE DRAWINGS

FIG. 1A is a side view of an automatic retail device in accordance with an aspect of the disclosure;

FIG. 1B is a front view of an automatic retail device in accordance with an aspect of the disclosure;

FIG. 2A is a front of an automatic retail device in accordance with an aspect of the disclosure;

FIG. 2B is a perspective view of an automatic retail device in accordance with an aspect of the disclosure;

FIG. 3A is a perspective view of an automatic retail device in accordance with an aspect of the disclosure;

FIG. 3B us a side view of an automatic retail device in accordance with an aspect of the disclosure;

FIG. 4 is a schematic view of an automatic retail device in accordance with an aspect of the disclosure;

FIG. 5 is a schematic view of an image recognition engine in accordance with the disclosure;

FIG. 6 is a flow chart of a method implemented by an automatic retail device in accordance with an aspect of the disclosure;

FIG. 7 is an image acquired by an automatic retail device in accordance with an aspect of the disclosure;

FIG. 8A is an image acquired by an automatic retail device in accordance with an aspect of the disclosure detecting the presence of hands in accordance with an aspect of the disclosure;

FIG. 8B is an image acquired by an automatic retail device in accordance with an aspect of the disclosure detecting a product in one of the hands in accordance with an aspect of the disclosure;

FIG. 8C is an image acquired by an automatic retail device in accordance with an aspect of the disclosure detecting a product in both of the hands in accordance with an aspect of the disclosure;

FIG. 9 is an image acquired by an automatic retail device in accordance with an aspect of the disclosure detecting the products offered for sale in the automatic retail device in accordance with an aspect of the disclosure;

FIG. 10 is a flow chart of a method implemented by an automatic retail device in accordance with an aspect of the disclosure;

FIG. 11 is a flow chart of a method implemented by an automatic retail device in accordance with an aspect of the disclosure;

FIG. 12 is a schematic view of an automatic retail device and the detection of products therein in accordance with an aspect of the disclosure;

FIG. 13 is a flow chart of a method implemented by an automatic retail device in accordance with an aspect of the disclosure;

FIG. 14 is a flow chart of a method implemented by an automatic retail device in accordance with an aspect of the disclosure;

FIG. 15 is a schematic view of an automatic retail device and the detection of products therein in accordance with an aspect of the disclosure;

FIG. 16A is a pair of images whereupon facial recognition software denied entry to an automatic retail device in accordance with an aspect of the disclosure;

FIG. 16B is a pair of images whereupon facial recognition software granted entry to an automatic retail device in accordance with an aspect of the disclosure;

FIG. 17 is a schematic view of a facial recognition and access system in accordance with the disclosure;

FIG. 18 depicts the view of an application enabling verification of age for access to an automatic retail device in accordance with the disclosure;

FIG. 19A is a right perspective view of a point-of-sale terminal device for fraud detection and security in accordance with the disclosure;

FIG. 19B is a left perspective view of a point-of-sale terminal device for fraud detection and security in accordance with the disclosure;

FIGS. 20A-20J depict screenshots of an application for interacting with a user account and an automatic retail device in accordance with the disclosure;

FIG. 21 depicts an automatic retail device and an ultraviolet light sterilization system associated therewith;

FIG. 22 depicts a perspective view of a shelf for placement in an automatic retail device in accordance with the disclosure;

FIG. 23 depicts a top view of a shelf for placement in an automatic retail device in accordance with the disclosure; and

FIG. 23 depicts a bottom view of a shelf for placement in an automatic retail device depicting the location of ultraviolet light sources in accordance with the disclosure.

### DETAILED DESCRIPTION

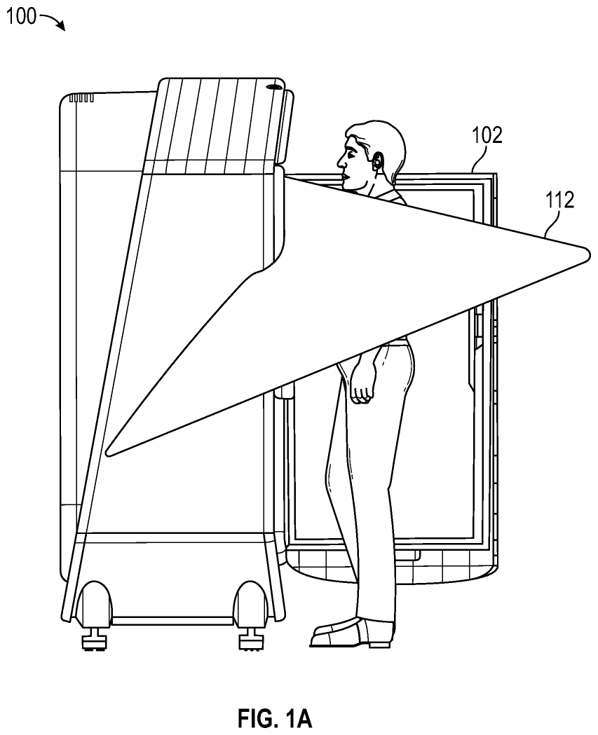

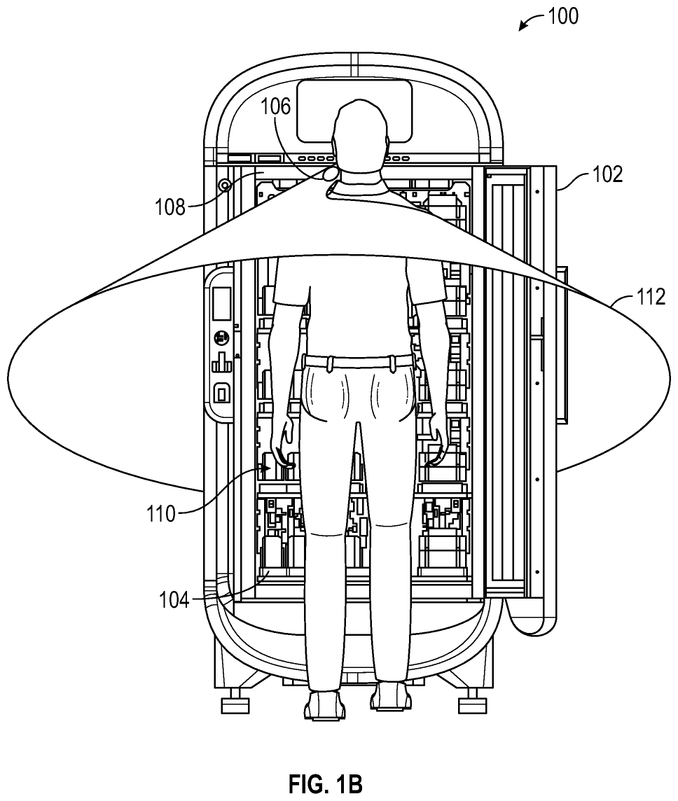

FIGS. 1A and 1B depict a side view and a front view of an automatic retail device 100 with its door 102 having been opened by a user who is standing at a position where products in the automatic retail device 100 may be removed from the shelves 104 mounted therein. A camera 106 is mounted along a bezel 108 forming a top portion of the enclosure 110 in which the shelves 104 and the products the shelves 104 support are located. The camera 106 has a field of view 112 which encompasses the space outside of the automatic retail device 100 from approximately a user's shoulders to the ground from a top-down perspective. As such the field of view generally captures the position and movements of the user's hands when they are in front of the user and not obscured by the user's body.

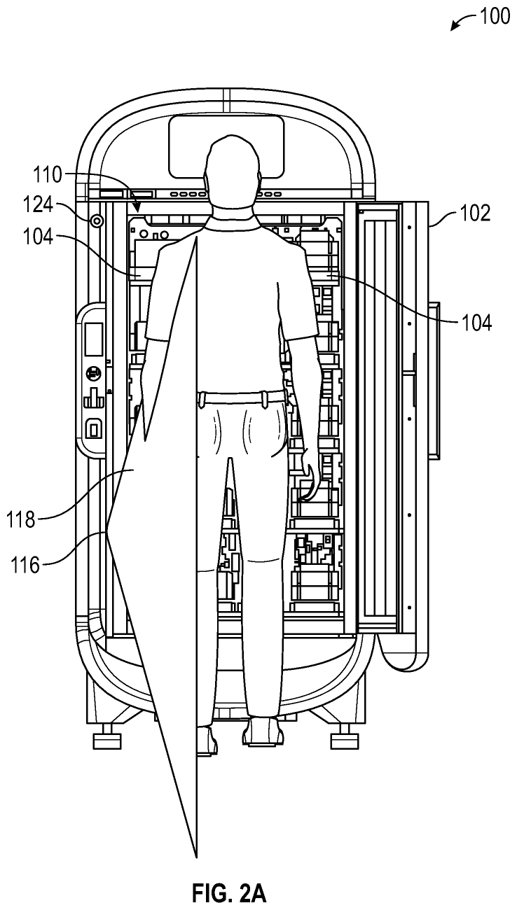

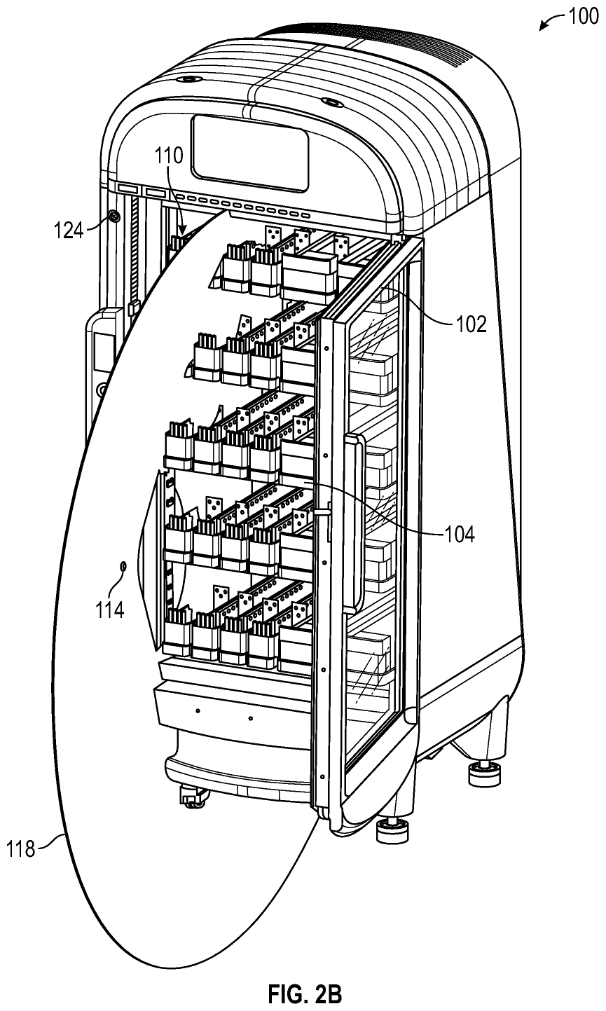

FIGS. 2A and 2B depict the automatic retail device 100. In FIG. 2A the user stands in in the same position as in FIGS. 1A and 1B with the door 102 open and access to the shelves 104 permitted. As shown in FIG. 2B, with the user removed, a second camera 114, located in a side bezel 116 of the enclosure 110 has a second field of view 118 which captures the area in front of the automatic retail device 100 from the left size of the user. As will be appreciated, if the door 102 is mounted to open in the opposite direction, then the second camera 114 may be mounted on the opposite side of the enclosure 110 of the automatic retail device 100. In such an instance, the camera 114 would have a field of view to capture the area in front of the automatic retail device 100 from the right side of the user.

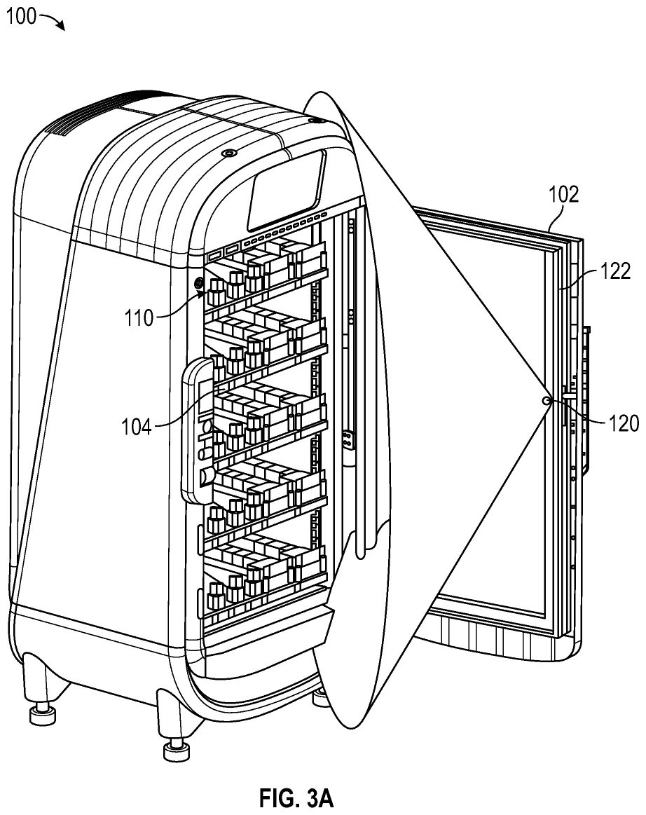

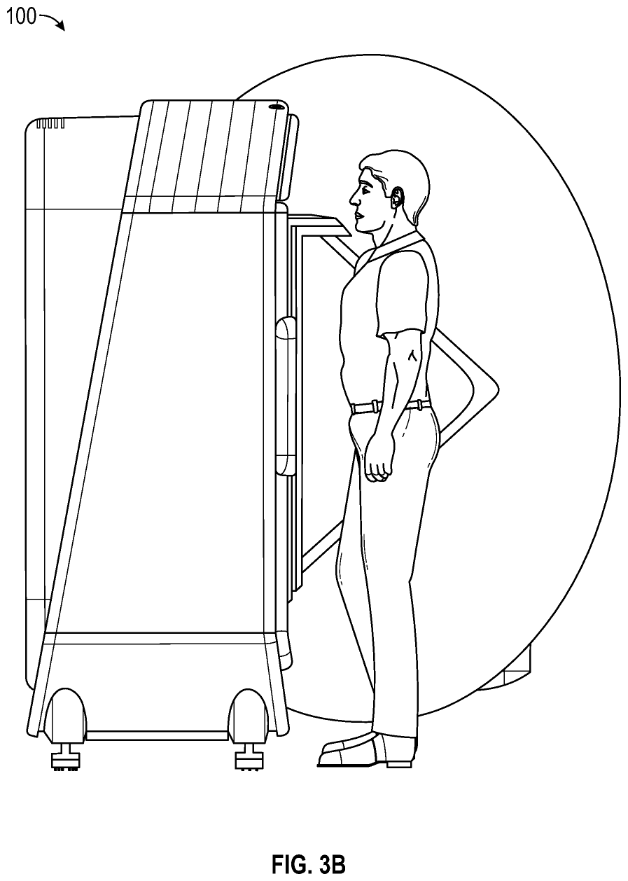

FIG. 3A depicts a perspective view of an automatic retail device 100 with the door 102 open and the enclosure 110 and the shelves 104 therein exposed. A third camera 120 is mounted on an interior bezel 122 of the door 102. The third camera 120 has a field of view that captures the entirety of the enclosure 110 and all the shelves 104. The field of view also captures, as shown in FIG. 3B the back and right side of the user. Again, if the door 102 opens in the opposite direction from that shown in FIG. 3A, the field of view is of the rear and left side of the user.

As will be appreciated, using the three different cameras 106, 114, and 120, the entirety of the space in front of the automatic retail device 100, is observable. As explained in detail below, the overlapping fields of view 112, 118, and 124 ensure that any movement of the user including hand movements, body movements, the removal or return of products from or to the shelves 104, and others are captured by the cameras.

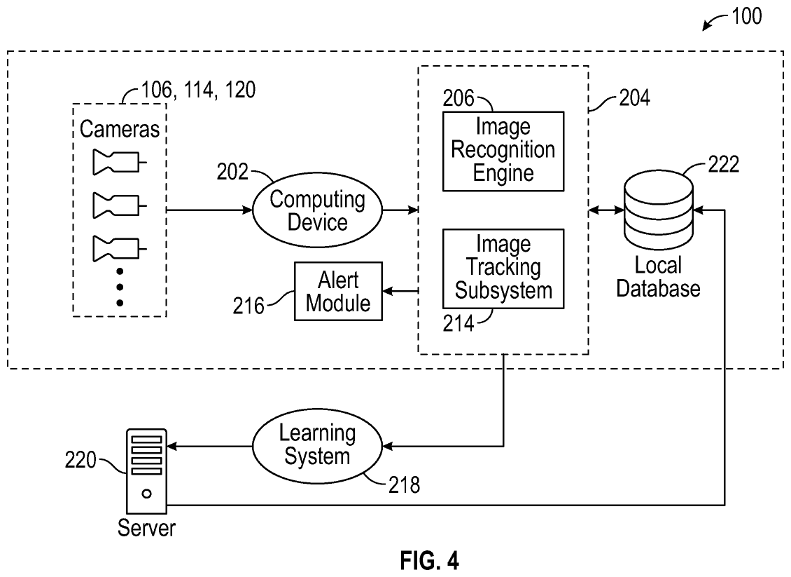

FIG. 4 depicts a schematic of automatic retail device 100 and specifically the system for capturing, storing, and analyzing images. As noted above the automatic retail device 100 includes cameras 106, 114, and 120 that monitor activity and captures images when the door 102 to the automatic retail device is opened. These images are transmitted to a computing device 202 which includes a processor (not shown) which can access a memory 204 storing a variety of applications that can be executed by the processor.

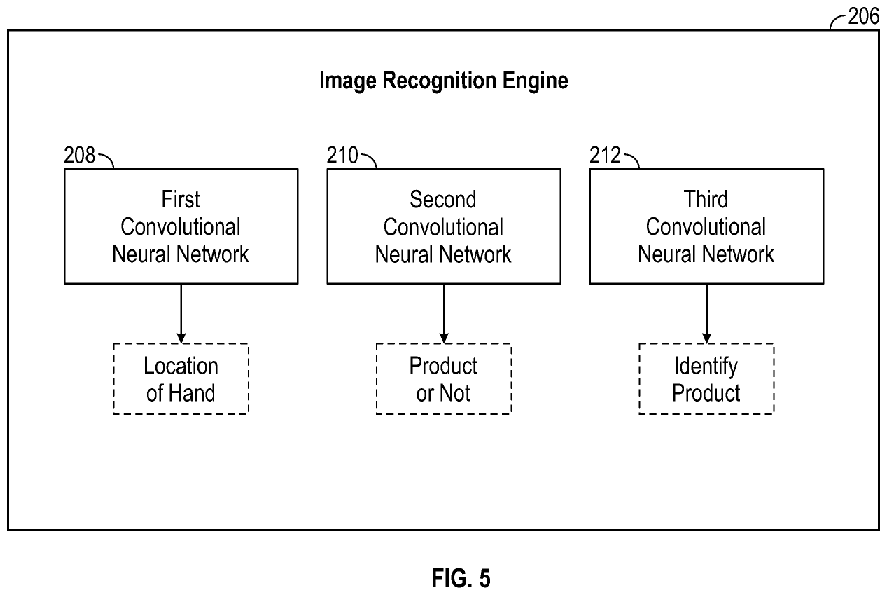

One such application is an image recognition engine 206. Details of the image recognition engine 206 can be seen in FIG. 5. The image recognition engine includes three separate convolutional neural networks that are configured to analyze the images captured by the cameras 106, 114, and 120 for certain features. As is known, a convolutional neural network is a form of artificial intelligence that is particularly suited for analyzing images. Each convolutional neural network can be separately trained to identify specific features that may be found in each image using optimized filters that are developed by training the convolutional neural network to identify a particular type of object that may appear in the image. The image recognition engine 206 of FIG. 5 includes three such convolutional neural networks. A first convolutional neural network 208 is trained to analyze an image received from the cameras 106, 114, and 120 to determine the location of a hand of the user. That is convolutional neural network 208 is trained to determine whether a hand can be identified in an image from the cameras 106, 114, and 120. A second convolutional neural network 210 is trained to determine whether a product (e.g., a product that has been stocked in the automatic retail device 100). A third convolutional neural network 212 is employed to determine what product is in the image. In some aspects, the third convolutional network 212 is trained to determine the identity of a product in the image based on the shape of the product in the image, though other factors may be employed for detection of a product in an image including color, size, and other features. In some instances, the shape can be assessed so long as at least a portion of the product is visible in the image. Thus, the image recognition engine 206 is employed to analyze the images from cameras 106, 114, 120 to determine whether the hands are visible in any image, whether a product appears in any image, and then what product is in the image.

A fourth convolutional network 214, and image tracking subsystem can be employed to analyze certain of the images to determine whether they evidence an act of fraud or theft. One example of evidencing fraud are suspicious hand movements. If suspicious behavior is identified, a signal is generated and transmitted to an alert module 216. Alerts may take many forms. For example, it may be as simple as an audible or visual communication to the user indicating informing the user of the products the system has identified that the user has removed from the shelves 104, and for which they will be charged. Alternatively, the alerts may be internal alerts which are transmitted to a learning system 218. The learning system 218 may include facilities for further automated assessment of the images from the cameras 106, 114, 120 in which a suspected theft is further analyzed to decide. In instances where a theft is detected, the user's account can simply be charged the amount of the merchandise, thus negating the effect of the theft on the operator of the automatic retail device 100. Additionally or alternatively, the learning system 218 may include a user-interface (not shown) where a specialist (i.e., a human) may analyze the images from that attempt to determine whether there has been an attempted theft of products from the automatic retail device 100. Where a theft is confirmed either automatically or manually, the result of this determination can be transmitted to a server 220 to update the charges on a user's account. In addition, under certain circumstances, as described in greater detail below, an alert may be transmitted to the user via an application they have downloaded to their smartphone regarding the transaction and allowing the user to challenge the determination. Additionally or alternatively, the user may be precluded from accessing any automatic retail device 100 based on their behavior either for a certain time period, or their account may be terminated preventing any future access by the user. In addition to transmission to the user's application, the limitation of access may be stored in the server 220 and further transmitted to a local database 222 to ensure that access is denied to the user regardless of the credentials provided. Further details on the denial of access and how that is effectuated are described in greater detail below.

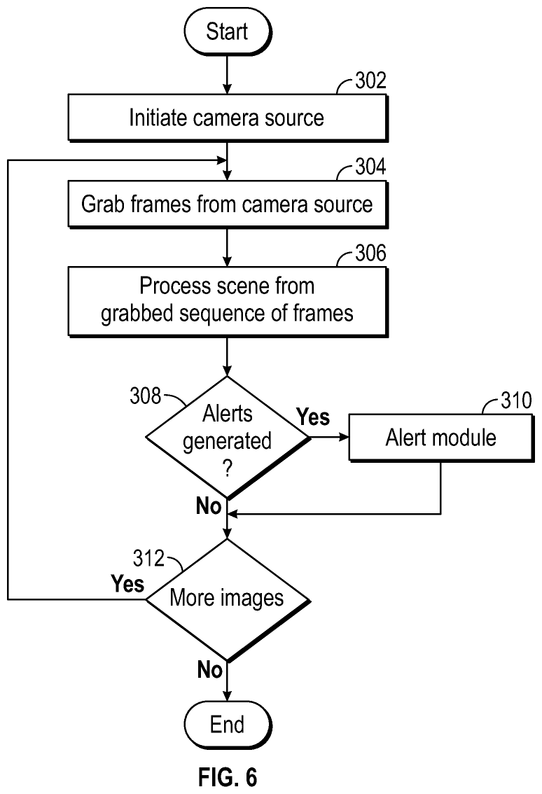

FIG. 6 is a flow chart depicting a method 300 of operation of the automatic retail device 100. At step 302, after access has been granted to the user the cameras 106, 114, 120 are initiated. At step 304 images are captured. These captured images are processed as described above to determine if individual images include hands, include products, and the identity of the products at step 306. At step 308 a determination is made whether an alert should be generated (e.g., whether a fraud or a theft is detected). If at step 308 the determination is yes, then a signal is sent to the alert module 216, and potentially to the learning system 218 at step 310 as described above at step 310. If the answer to the inquiry at step 308 is no, or after the transmission to the alert model at step 310, the method returns to step 312 to determine if additional images are being captured. If no further images are being captured to method ends, however, if images continued to be captured, the method returns to step 304. The process continues until the door 102 closes and no further images are being acquired by the cameras 106, 114, 122.

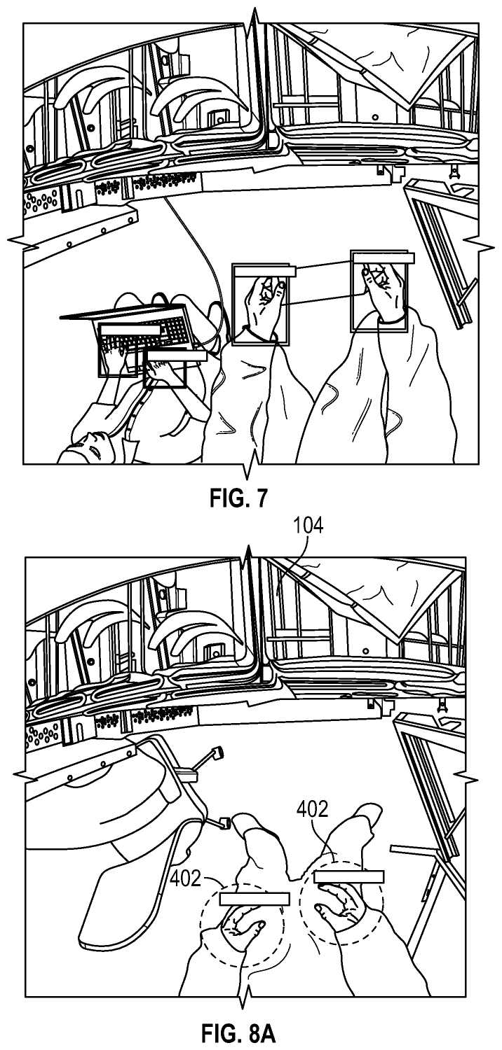

Exemplary images from each camera can be seen in FIGS. 7-9. FIG. 7 depicts an image from camera 106 (i.e., the top-down view). As can be seen in FIG. 7 the first convolutional neural network 208 has identified the hands of both an individual standing before the automatic retail device 100 as well as a second person who is in the field of view 112. Though, a product can be seen in one of the user's hands, the image of FIG. 7 has not yet undergone the analysis of the second convolutional network 210 to detect the existence of the product.

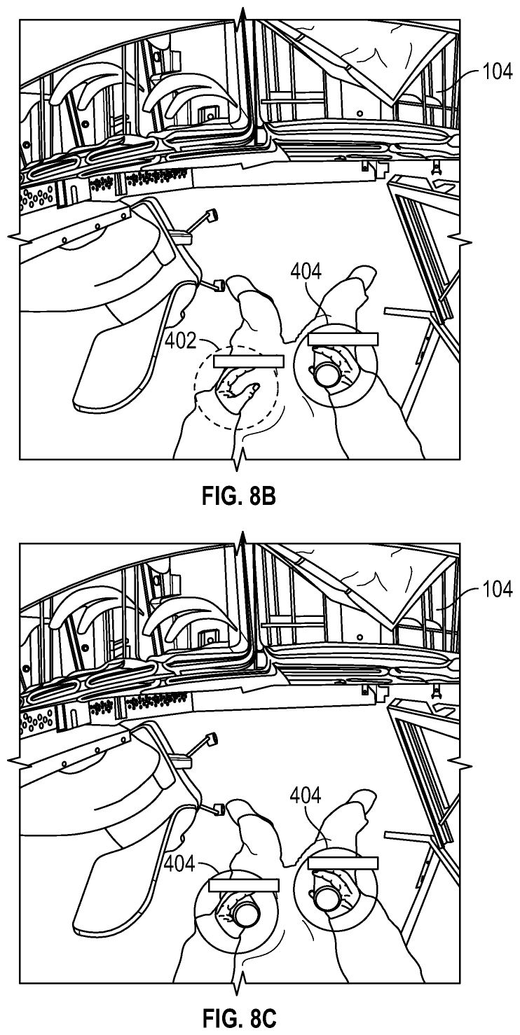

FIGS. 8A-8C show a progression of images as a user interacts with the automatic retail device. As can be seen from the image the camera 106 is positioned and oriented such that even the top shelf 104 of the automatic retail device 100 is in view as is some of the area beyond the boundary of the automatic retail device 100. In FIG. 8A the hands are detected by the first convolutional network 208 and are identified by a first indicator 402 circling each hand. In FIG. 8B, a first product is detected within one of the hands of the user. The hand holding the product has a second indicator 404 circling the hand with the detected product. In contrast, the hand having no product in it has the first indicator 402 circling the hand. Finally, FIG. 8C shows both hands being circled by the second indicator 404.

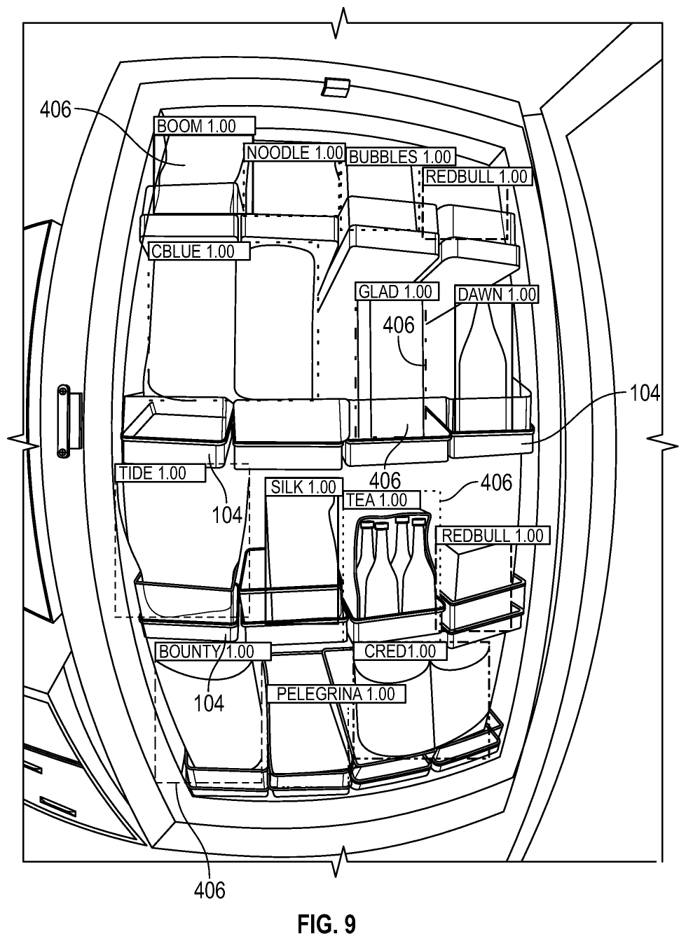

FIG. 9 shows an image captured by the camera 120 mounted on the door 102. In the image the shelves 104 are each clearly visible as are each product located on the shelves 104. Each product includes an identifying box 406 drawn around the product. The third convolutional neural network identifies each of these products based on their attributes as described above. In some instances, this identification can be part of the training for the convolutional neural network 212. Alternatively, this scanning by the camera 120 may be part of an inventory system that checks with each opening of the door 102 for which products are visible within the automatic retail device 100. The identification of the products within the automatic retail device 100 at any time enables the convolutional neural network 212 to determine from the images of a user holding a product more speedily what that product is. In accordance with one aspect of the disclosure less than 10% of the product needs to remain visible for its identity to be determined by the third convolutional neural network 212.

The images of FIGS. 8A-8C show a progression of images that are captured by camera 106. Similar images, from different perspectives are captured by cameras 114 and 122. These images may be timed still images (e.g., every 2 seconds) or video images (e.g., 30-60 images-per-second). Regardless of the frequency of the images, the detection of the hands and the product(s) enable tracking of both the hands and the product(s) as the user interacts with the automatic retail device 100 and removes or replaces products on the shelves 104. Though not shown, but as described above, the third convolutional neural network 212 can identify the product in the user's hands. Further, by tracking the hands of the user and the movement of the product in the images, the fourth convolution neural network 214 (the image tracking subsystem) analyzes the user's interactions with the automatic retail device 100 and products for suspicious activity. This may include features such as identifying odd shaping of the hands while interacting with a product, and odd movement of a hand while interacting with a product, odd body movements, determining that a product returned to a shelf is not the actual product but is a dummy product (e.g., a 12 oz water bottle returned to a location a 12 oz soda was removed from on a shelf 104). This last example is a combination of the results of the third convolutional network 212 determination and the fourth convolutional neural network 214 working in concert to notice that the identity of a product returned to a shelf 104 does not correspond to the identity of the product removed from that shelf 104.

The images acquired by the cameras 106, 114, and 122 may be individually logged and stored in either the database 222 or transmitted to the server 220 and stored there. These images can be stored in a time sequence and associated the individual transaction and with the individual user's account or the presented credit card number so that the images for any individual transaction can be easily searched for an identified in the database 22 or on the server 220 to analyze the individual transaction or the transactions of a particular user. As will be appreciated the ability to review these transactions and images allows for the collection of significant evidence that can be used by law enforcement in the prosecution of a user believed of theft or fraud in connection with the use of the automatic retail device.

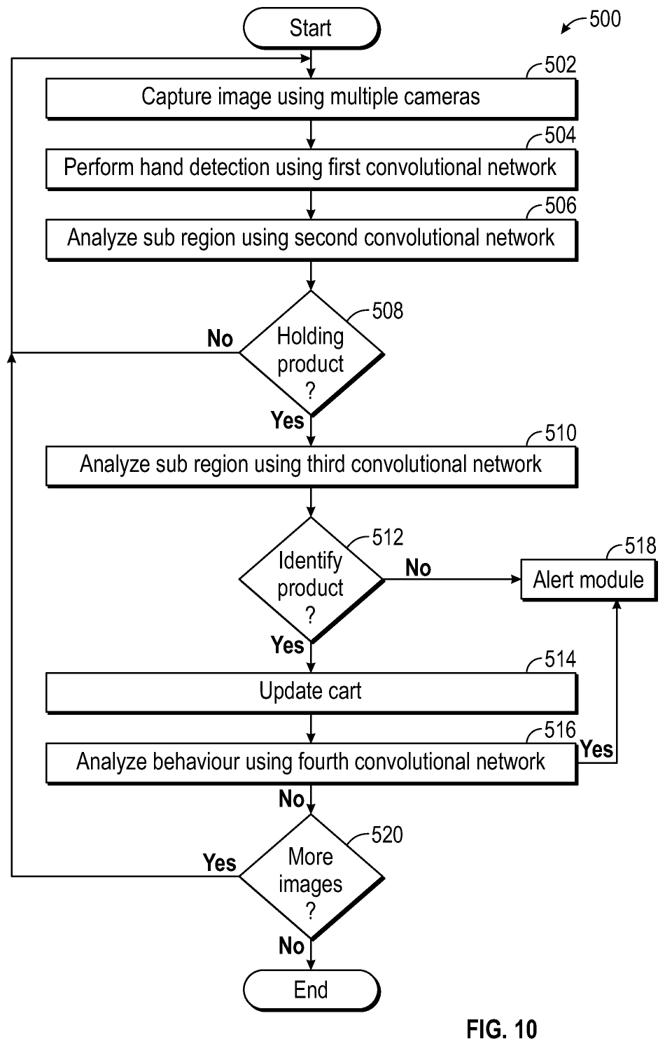

FIG. 10 details a method 500 in accordance with the disclosure for detecting a user's hands, products, and identifying the product. At step 502 following opening of the door 102 of the automatic retail device 100, images are captured from the multiple cameras 106, 114, and 122 (e.g., the images of FIGS. 7-9). At step 504 the first convolutional 208 neural network begins analyzing the images to determine the presence and location of the user's hands. At step 506 the second convolutional neural network 210 analyzes the images to detect the presence of a product. As will be appreciated, the second convolutional neural network 210 may only analyze a sub-region of the image, for example, that subregion may be just the portion of the image in which the hands are detected (e.g., the portion within the indicators 402 of FIG. 7. At step 508 the method assesses whether product is being held (e.g., is in the hands of the user?). If no product detected as being held the method returns to step 502 and acquisition and analysis of the images continues until the door 102 is closed. If a product is detected at step 508, the method proceeds to step 510 where the third convolutional neural network 212 analyzes the images. As with the second convolutional network 210, again the third convolutional neural network 212 may only analyze a subregion of the image, specifically the region in which the hands and the product are detected (e.g., the region outlined by indicator 404 in FIGS. 8B and 8C). At step 512 a determination is made whether the product in the images can be identified. If the product is identified the product is added to the user's cart of products for purchase by the user at step 514. At step 516 the fourth convolutional network 214 (i.e., the image tracking subsystem) analyzes the images (or subregions of the images) to track the hands and the product to determine any fraud or theft. If a fraud, theft, or even a suspicious act is detected a transmission may be sent to the alert module 216 for escalation of the analysis as described herein above for further analysis at step 518. Additionally at step 512 if the product in the user's hands is not identifiable at step 512 a transmission may be sent to the alert module 216 for further escalation as described above at step 518. In some instances, the presence of an unidentified product may be completely benign, and not be evidence of fraud, theft, or suspicious act on the part of the user. For example, the user may be holding a smartphone that they used to access the automatic retail device 100. The alert module may, as described above, have additional image processing capabilities or a manual review may be undertaken to assess the product in the image. At step 520 a determination is made whether additional images are being captured. If images are still being captured (i.e., the door 102 remains open) then the method returns to step 502. If the door 102 has closed and no more images are being acquired, then the method ends. Those of skill in the art of automatic retail devices 100 will understand that will the closure of the door 102, the transaction will be ended. All products removed from the shelves 104 will be tallied and the customer charged for these products either via a credit card presented to open the automatic retail device, or via an account that the user has set-up with the operator of the automatic retail device 100.

As will be described in greater detail below, the shelves 104 include weight sensors. Those weight sensors detect the removal or replacement of products from the shelves 104. An application on the computing device 202, which includes a planogram (a list of products, weights, and location in the automatic retail device 100 of the products) stored in the memory 204 detailing the location of items in the automatic retail device 100, compares the location of a detected weight change and the amount of the weight change to determine which product and how many of that product have been removed from a shelf 104. The computing device 202, utilizes the weight-based information in combination with the computer vision information (e.g., the image-based detection of hands and products as described herein), to correlate the determination of the products removed for which the user should be charged and for the detection of any fraud, theft, etc. For example, in instances where weight of a product removed from a shelf 104 substantially corresponds to the weight of a product returned, the image analysis may be able to detect any differences between the two products and thus the attempted fraud or theft. Similarly, where the exterior of the product removed and returned to the shelf 104 substantially correspond, a difference in weight between the two (even a slight one of just a gram or an ounce) may be sufficient to detect the fraud or theft. Finally, where both the weight and the images of the product indicate that the product removed and the product returned appear to be the same, tracking of the hands of the user during the transaction may reveal some attempted slight of hand or other suspicious hand gestures that indicate there may be an attempted fraud or theft from the automatic retail device 100.

Though described herein above with respect to the weight sensitivity of the shelves 104, the planogram of the contents of the automatic retail device 100 is also useful in the product detection aspects of computer vision and image analysis as described herein. With the planogram stored in memory, the convolutional neural network 212 can narrow its focus to just those items that are intended be in the automatic retail device 100 to more readily and quickly identify the product held in a user's hands as either a product that is intended to be in or removed from the automatic retail device 100 or a product which is not listed on the planogram. In this way, much like limiting the area of analysis for product detection to just that portion of the image in which the hands or the product appears (i.e., a subregion of the image) to limit the processing power required for the image analysis and enabling greater accuracy in the product detection by the third convolutional neural network 212.

As described above, convolutional neural networks must be trained to detect the specific features of the images that they are to focus on. These convolution neural networks can be updated, with the actual acquired images from the automatic retail device 100, with new gestures and new tracking to result in ever more efficient and exacting determination of the location and tracking of the user's hands and products. As will be appreciated, using hundreds and even thousands of automatic retail devices 100, the data set of images increases at an incredible rate and reduces the possibility for even the most creative and skillful fraudster or thief to overcome these protections. This enables the operator of the automatic retail device 100 to have confidence that the products placed in the automatic retail device will not be the subject of theft or fraud despite being unattended by a human.

The images and the tracking of the hands and the products as manipulated by the users may be transmitted to a learning system 218 so that these behaviors and hand gestures can be analyzed. In some instances, these behaviors and hand gestures can be used to further train the convolutional neural networks 208-214. Further, these updates this additional training of the convolutional neural networks can be transmitted back to the automatic retail devices 100 to allow for ever increasing abilities to provide accurate results.

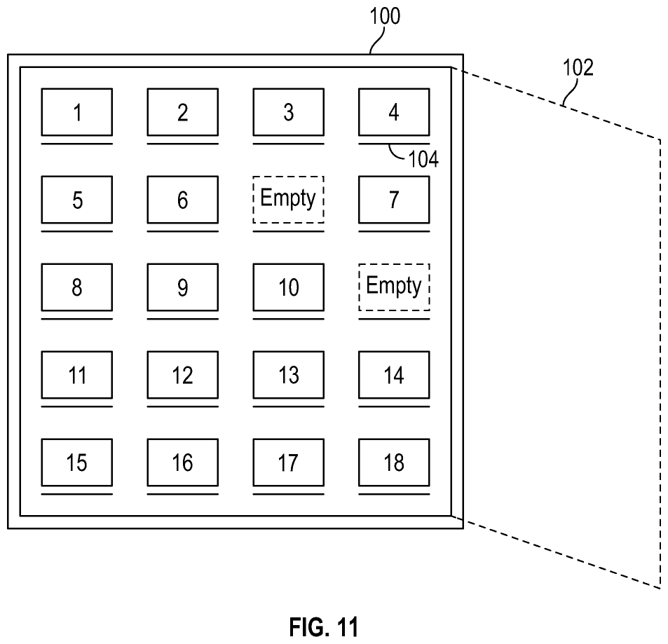

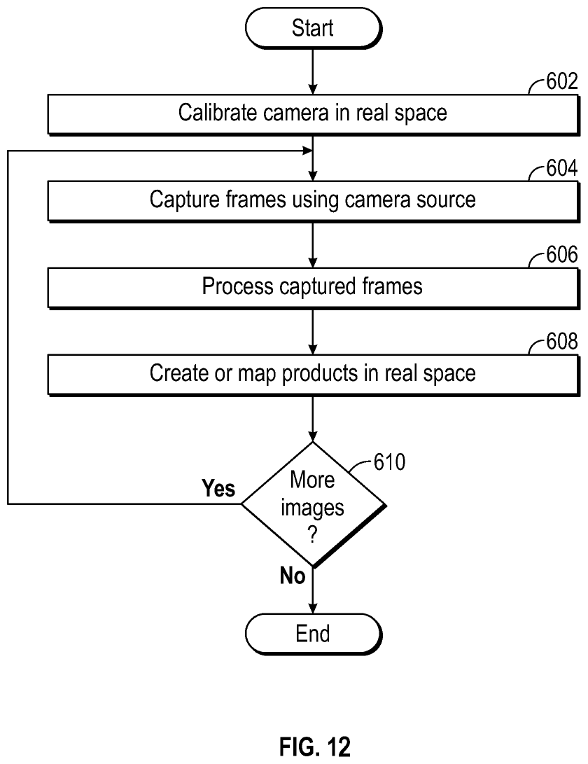

Described herein above is a planogram that details where the products are located within the automatic retail device 100. In one aspect of the disclosure the planogram is generated by an operator of the automatic retail device 100 user prior to the loading of products in the automatic retail device 100 (e.g., via an application running on a computing device in communication with the automatic retail device 100). However, the camera 120 mounted on the door 102 enables other aspects of the disclosure. For example, FIG. 11 depicts a schematic of an image acquired by the camera 120. This image can be used to either create a planogram or to update a planogram. FIG. 12 depicts a method 600 in accordance with the disclosure for generation of a planogram from the image acquired at FIG. 11. The method 600 may begin with the operator of the automatic retail device 100 opening the door and allowing the camera 120 to calibrate itself (e.g., allowing the camera to adjust its focus and resolution so that the images acquired capture the entirety of the enclosure and all the shelves 104 of the automatic retail device 100 at step 602). Calibration may be required each time that planogram development is required or may only be required in an initial set-up of the automatic retail device 100. Once calibrated, the camera 120 captures images, such as that shown in FIG. 11 at step 604. At step 606 the images acquired are processed and for example the second and third convolutional neural networks 210, 212 are employed to detect the presence of products and to identify those products that appear in the image. Processing of the images may include mapping the pixels of the images to standard measurement units. The processing of the images may further include extracting features of the products on the shelves 104 based on their orientation and location within the automatic retail device 100 that can be used to identify the products. At step 608 a map of the location of the products in the automatic retail device is generated. This map may be stored in the memory 204 as hashed embedded vectors. The result of this mapping can be seen in FIG. 11 where each item on each shelf is identified, here by numbers 1-18. Each number corresponds to a product that is present in the automatic retail device 100 in addition, there are at least two shelves 104 that are noted as empty. This may occur where for example the product to be stocked on that shelf is not currently available to the operator. Once the door is detected as closed and no more images are being acquired, at step 610 the process ends, and the map of the products, the planogram, is considered complete and stored in the memory 204 of the automatic retail device 100. If, however, images are still being acquired, then the process reverts to step 604 and continues as described above. This allows for updates of the planogram before being considered final. Though described above with respect to the use of the second and third convolutional neural networks 210, 212, the instant disclosure is not so limited.

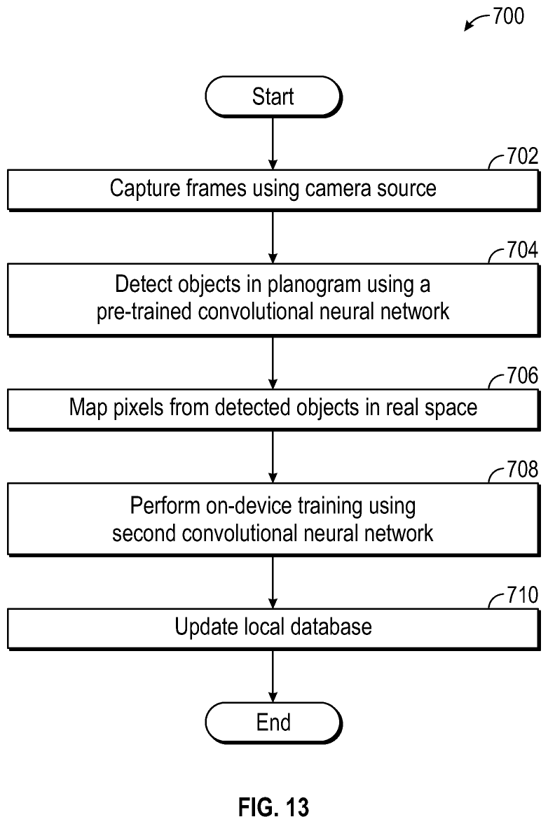

A further method 700 is depicted in FIG. 13 for the generation of a planogram in accordance with the disclosure. At step 702 images are captured by the camera 120. At step 704 the images are analyzed by a pre-trained convolutional neural network to determine if objects are present in the image acquired by the automatic retail device 100 at a particular location. The pre-trained convolution neural network may be one that is generic to all automatic retail devices 100. At step 706 the pixels of the objects in the images acquired at step 702 are mapped to localize the objects in the image. At step 708 the mapped and localized images are analyzed by a second convolutional neural network. The analysis at step 708 extracts features from the localized images in the form of vectors. These features may then be stored in the database 222 to define the products in the planogram, or if a planogram already exists, the planogram stored in the database 22 may be updated at step 710.

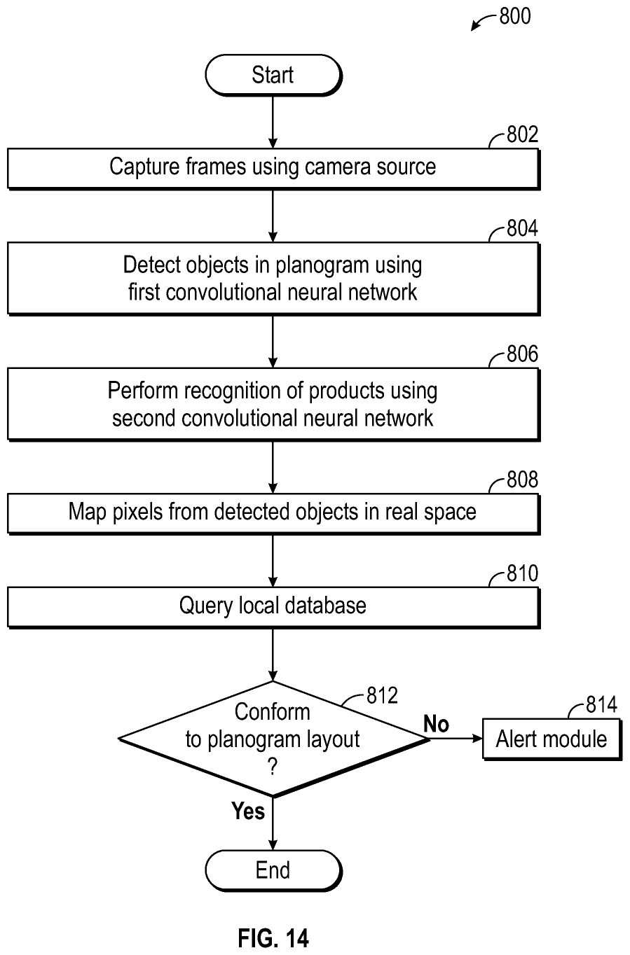

FIG. 14 depicts a further method 800 regarding the use of camera 120 in conjunction with assessing the products within the automatic retail device 100. The method 800 may be utilized each time the door 102 of the automatic retail device is opened by a user to confirm or verify the contents of the automatic retail device at the initiation of the transaction. At step 802 the camera 120 acquires images of the shelves 104 and the objects thereon, as described herein above in connection with methods 600 and 700. This may be a single image or multiple images that are acquired before the user is present in the image and all the shelves 104 of the automatic retail device 100 are visible in the image. A first convolutional neural network, which may be a generic convolutional neural network common to all automatic retail devices 100 or may be specifically trained for that specific automatic retail device 100, analyzes the images and detects the presence of products on the shelves 104 in the automatic retail device 100 at step 804. At step 806 a second convolutional neural network can analyze the images in which products are detected to extract features from the images. As described above, the portion of the images with the product may be isolated or localized from the entire image so that the extraction of features is focused only on those portions of the image in which the product resides. At step 808 the pixels of the detected products (e.g., the extracted features) are mapped to create a map of the products as they appear in the images. At step 810, the planogram is extracted from the memory 204. At step 812, the map of products is compared to the planogram to confirm that there is a match. If there is a match, that conforms that all the products that are supposed to be in the automatic retail device 100 are there and are detected by the second convolutional neural network, then the process ends. If there is no match, then a signal is sent to the alert module 216 at step 814. As described above, the alert module 216 may conduct additional automatic image analysis or provide the images for a human to review for either confirmation that there is indeed an issue or determination that the second convolutional neural network failed to accurately identify one or more products in the automatic retail device 100.

Though described above with respect to accurately determining that the contents of the automatic retail device 100 at the initiation of a transaction, the systems and methods described herein are not so limited. For example, as noted above, when a particular shelf is determined to have no product and is empty, this information can be sent to an operator to indicate the need for stocking of that item. Alternatively, it can be an indicator that no item has been stocked on that shelf 104 and that the operator can undertake the necessary steps to identify a product to be stocked at that location in the future. As will be appreciated, many of the determinations regarding the need for restocking may be based on the weight sensors (described below) and used to measure the contents of the shelves 104 as this can be employed when only two or three of a particular product remain on a given shelf 104, and before zero products remain on any particular shelf 104.

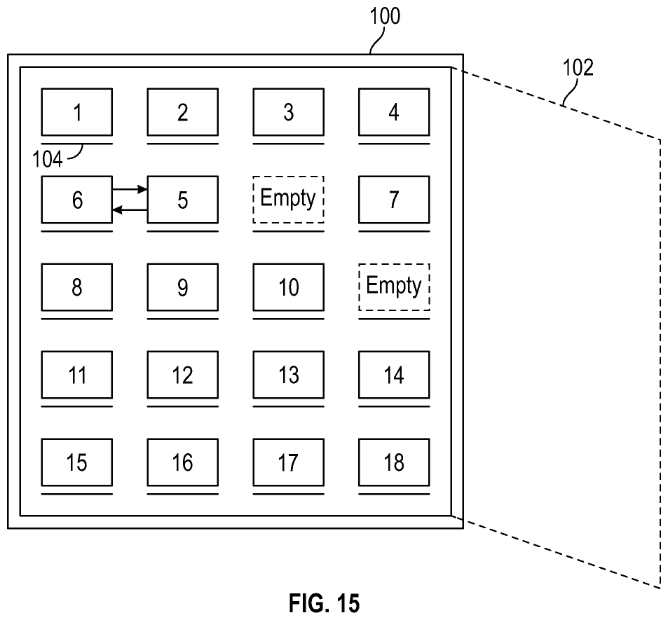

Still a further aspect of the disclosure can be seen with reference the method 800 and the image of the automatic retail device 100 in FIG. 11. In addition to performing the method 800 at the beginning of a transaction by a user, the same process may be undertaken during the transaction or at the close of the transaction. In such an instance, a comparison may be made between the image as depicted in FIG. 11 taken at the beginning of the transaction, and the image of FIG. 15. As can be seen, the items 5 and 6 have been switched in their location in FIG. 15 as compared to FIG. 12. If the transaction is still on-going, the automatic retail device may have the capability to alert the user of the mis-replacement of the item and request they replace the products correctly. Alternatively, in instances where the weight of the two items is different, this recognition of the change in location of items 5 and 6 can be employed in combination with the known weights of the two items to ensure that the user is not incorrectly charged for items that were not in fact removed from the automatic retail device 100. Similarly, in some instances, the user may be charged a fee because of this improper replacement of items. As will be appreciated, all these determinations may require both the imaging and convolutional neural network analyses as well as the weight sensing systems and methods described herein to work in combination with each other to make independent determinations that can be cross verified to ensure proper charging of the users that result from the transactions and where necessary determine the fraud or theft as described herein.

The automatic retail device 100 described herein is typically used by users who have established an account. Details of establishing that account are described in greater detail below, however, this account will typically require a user to provide biometric data (e.g., thumb print, voice data, retinal scan, or other) as well as payment resolution data (e.g., a credit card to be charged or a bank account to be debited upon removal of items). Use of Google Pay, Apple Pay, Android Pay, and other related systems may also be enabled without departing from the scope of the disclosure. However, the automatic retail device 100 is not so limited. In instances where a user has not established an account, the door 102 can be opened and a transaction initiated by the presentation of a credit card, debit card or other payment vehicle.

As will be appreciated, by accepting credit cards some individuals my a seek to present a stolen credit card. While the credit card issuing company is generally responsible for the charges beyond $50, the retailer may not be made whole. To address this shortcoming, a further aspect of the disclosure is directed to the use of a camera 124 (FIGS. 2A and 2B) mounted on the front of the automatic retail device 100. For users with an account the camera 124 may be used for retinal scanning to allow access, however, the camera is not limited to acquiring retinal images. Instead, the camera 124 can scan the area around the automatic retail device 100 and acquire images anytime that a potential user enters within a predetermined distance from the automatic retail device. The images acquired by the camera 124 can be used in several ways including assessing the amount of foot traffic and the demographic data of that foot traffic for the area around the automatic retail device. This data can provide actionable information to the operator of the automatic retail device 100 regarding whether the automatic retail device 100 should be moved, what types of products to stock in the automatic retail device 100, the rate of interaction with the automatic retail device 100 for the observed foot traffic, the types of incentives to offer to potential users of the automatic retail device, and even if users with accounts are passing the automatic retail device 100 without interacting with it.

In addition to the above, when a user, who does not have another means of accessing the automatic retail device 100 presents themselves and a credit or debit card to gain access the camera 124 ensures that one or more images of the user are captured and associated with the transaction. In one aspect, the camera 124 can observe and capture images of an individual that approaches the automatic retail device. The imaging may commence approximately 2.5 meters (9 feet) from the automatic retail device 100 and continue until the potential user initiates interaction with the automatic retail device 100. During this interval, images are captured by the camera 124 can process the images and using facial recognition software resident on the automatic retail device 100 compare the images to all authorized users who have an account to identify the potential user. This determination can be made by comparing acquired images of a potential user with images stored in the database 222, as well as those stored on the server 220.

Where the automatic retail device 100 can analyze the images captured by camera 124 and, using facial recognition software resident on the memory 204 and executed by a processor, identify the potential user as an account holder (e.g., based on image recognition), the automatic retail device 100 may automatically unlock allowing the account holder access to the products in the automatic retail device 100. As will be appreciated, this will initiate a transaction based solely on the facial recognition or matching of the image acquired by the camera 124 to prior images of the account holder. In at least one aspect of the disclosure, the automatic retail device 100 may include a mechanism (e.g., gear drive, spring driven, gas strut system, or others) to move the door 102 to an opened position once the potential user is confirmed as an account holder, thus allowing the account holder to initiate a transaction without having any contact with the automatic retail device itself. Even if not recognized via facial recognition, as described above, camera 124 may still be employed for iris scanning to identify the account holder and initiate a transaction without any touching of the automatic retail device 100 by the account holder. Alternatively, the automatic retail device may request further identification to initiate a transaction including thumbprint, voice, or a credit or debit card.

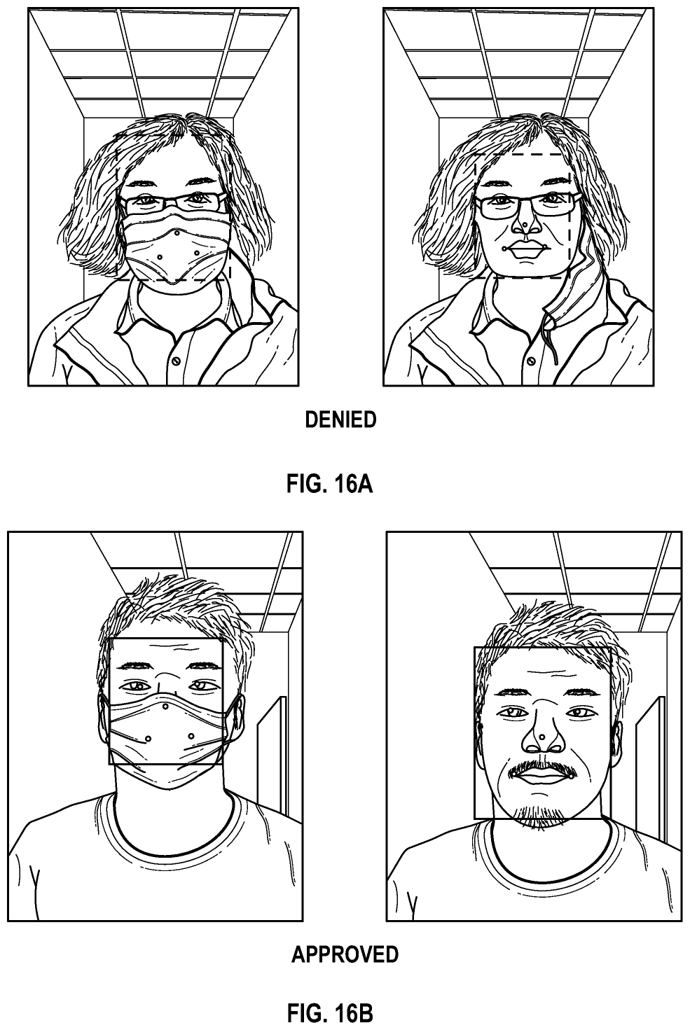

FIG. 16A depicts a set of images of a person both with a mask and without a mask. Based on the features that can be observed of the person, their access to the automatic retail device 100 is denied because the features of the face of the person, regardless of the presence of the mask does not match that of an authorized user. In contrast, in FIG. 16B, whether with or without the mask sufficient commonalities are found between the images and those stored in memory 204 or database 222 or server 220 to determine that the individual is an authorized user and that access to the automatic retail device should be granted. Some of the features that may be relevant include an estimated age of the person in the image, the perceived gender of the person in the image, the presence of a smile, emotions present in the image (e.g., smiling, calm, frowning, etc.) Along with the identification certain features in the image including distance from temple to temple of the individual, width of nose, location and relative spacing of cheek bones, triangulation between cheek bones and chin, and other features identifiable in the image allow for high confidence determinations of image recognition for comparison to images of authorized users or for comparison to banned users, as described below.

Where the potential user does not have an account, they may present a credit or debit card at the automatic retail device 100. Having accepted the credit or debit card, the door 102 unlocks and access is granted to the products stored therein. While granting access to the automatic retail device 100, one or more of the images acquired by the camera 124 are associated with the transaction. This image or images include clarifying characteristics of the person presenting the credit or debit card. Each transaction also includes a unique transaction identifier. All this data is stored together in the database 222 and/or on server 220 for future use if necessary.

As can be understood, the issuing authority of the credit card or debit card may reject a transaction or identify a transaction as fraudulent or committed with the use of a stolen credit or debit card. Often this is only done after the transaction is complete and the user has left the scene with both the credit or debit card and the products purchased therewith.

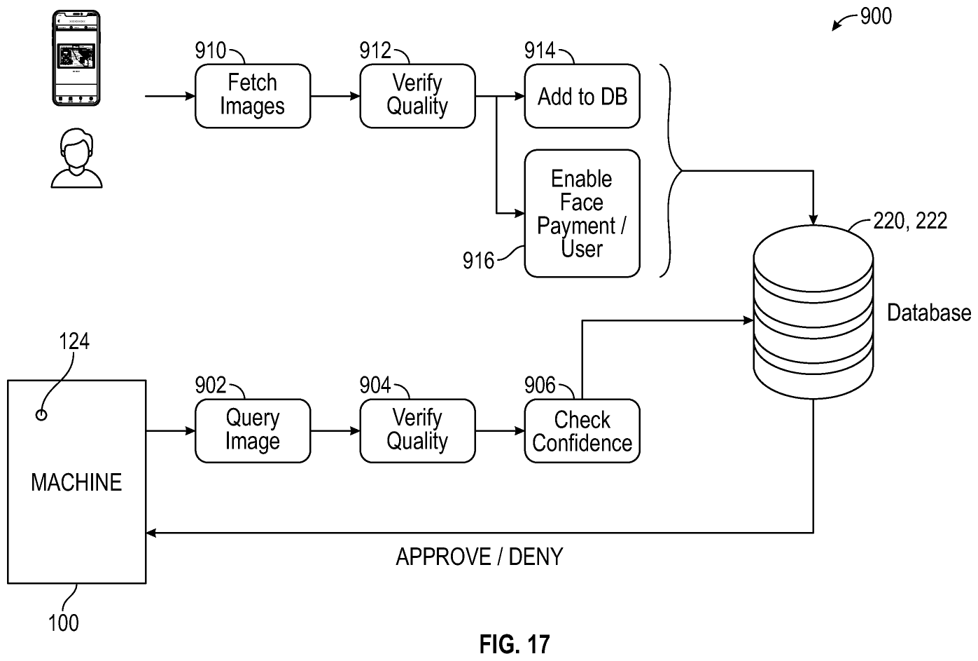

The method and systems described herein cannot prevent the initial fraudulent transaction. However, the systems and method described herein can prevent the same individual from gaining access to any automatic retail device 100, anywhere in the world. FIG. 17 depicts a workflow and schematic 900 in connection with the facial recognition systems of the disclosure. The automatic retail device 100 includes the camera 124 and acquires images as a potential user as they approach the automatic retail device 100, as described above. Once acquired, the facial recognition software resident on the memory 204 undertakes several steps including analyzing the image at step 902, for example, in the analysis a convolutional neural network may extract unique features of the person present in the image and compare them to features extracted from prior images either of an account holder or of an individual who has previously presented a credit or debit card. At step 904 the quality of the image may be verified. At step 906 a confidence check 906 may be undertaken. The confidence check may include querying a database (either database 222 or one on the server 220) to determine whether an image exists that has similar features to those extracted from the image acquired by the camera 124. If the features extracted from the image captured by the camera 124 match the features of an image of a user who is associated with a transaction that has been identified as fraudulent or the use of a stolen credit card, the facial recognition software may return a signal to the automatic retail device 100, to refuse access to the potential user based on this prior experience.

Over time an extensive collection of users who have attempted to use a stolen credit or debit card can be created and all such persons can be denied access to the automatic retail devices worldwide. In this fashion, the network of automatic retail devices can greatly limit the theft and loss of products that an operator may experience. In addition to the organically created database of individuals that are not to be granted access based on their prior bad behavior, the database 222 or server 220 may be supplemented with criminal record data for individuals that have been charged with or convicted of fraudulent credit card use or the use of stolen credit cards in other transactions. In addition, the record of the specific attempted transaction may be sent to the police or the credit card company for further action (e.g., identifying the location of the individual so they can be arrested for their past interaction or so that the credit card company can make an assessment whether the presented credit card should be cancelled to prevent its use elsewhere).

As will be appreciated, the above example works on a fool me once shame on you, fool me twice shame on me principal. In this manner there will be no fool me twice, as the individual will be locked out of all devices, worldwide that share the same fraud detection system. In this way operators of the automatic retail device 100 can reduce their exposure to theft. Where an individual approaches the automatic retail device 100 and is denied access, they will as a matter of course have an opportunity to contact customer service and seek a work around, through which customer service may initiate a transmission to the automatic retail device 100 to allow the door to open and a transaction to be initiated with the presented credit card. Further, any refusal to grant access to an individual may be reviewed to determine whether denial of access is warranted or whether a mistake was made.

FIG. 17 also details a further aspect of the disclosure. Specifically, FIG. 17 depicts the use of an application on a smart phone for creating an account. As part of that process the future account holder is requested to capture an image of their face with the camera on the smartphone. An application on the smartphone fetches the acquired images at step 910. As with the images acquired by the automatic retail device 100, the quality of the image is verified at step 912 and then added to the database of images for account holders at step 914. In addition, the account holder may authorize the use of facial recognition features as described herein to achieve access to an automatic retail device 100 at step 916. Once captured, and the financial institution information is also captured for the account holder, anytime the account holder presents themselves before and automatic retail device 100, they can be granted access based solely on the recognition of their facial features as described herein.

One of ordinary skill in the art will recognize that much of the processing described above of the images may be performed in a cloud computing environment. In one implementation, the features of the images are extracted locally by the software stored in memory 204 on the automatic retail device 100. These extracted features may then be transmitted to a cloud computing solution (e.g., server 220) for determination of a match to either an account holder authorized to access the automatic retail device 100 or a person who has previously presented a fraudulent credit or debit card and is banned from accessing the automatic retail device 100. Once a match is determined a signal is returned to the automatic retail device 100 either granting access and allowing the door 102 to open or declining entry. In some instances, the operator of the automatic retail device may also receive a signal including the image of the person who has been denied access, this image may be viewable in an operator's application running on a phone or computer, described in greater detail below.

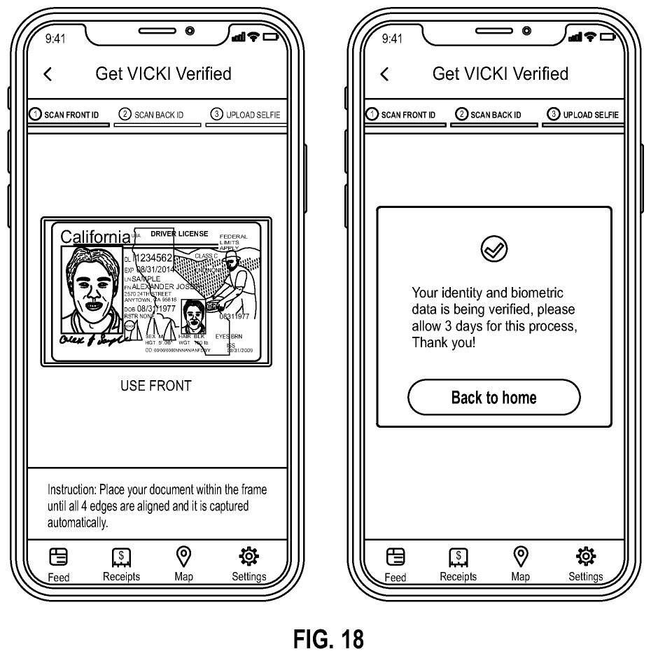

A further aspect of the disclosure is directed to age verification of an account holder. As will be appreciated, there are often products which are age restricted, but may nonetheless be quite desirable to offer for sale in an automatic retail device 100. Some examples of products requiring age verification include alcohol, marijuana, CBD products, ammunition, cigarettes, vaping products, and others. To enable age verification, an account holder may be asked to capture an image of a government issued identification such as a driver's license, passport, or other acceptable form of identification. In addition, the user may be required to capture an image of themselves that can be used for comparison purposes by the application to confirm that the ID and the image match. As shown in FIG. 18, these images are associated with the account of the account holder. The smart phone may itself or communicate with a device capable of performing facial recognition on the image in the proffered identification to confirm that the account holder and the identification are for the same person. In addition, the application on the smartphone of the user may be enabled to request confirmation of the proffered identification from the issuing authority (e.g., the state or country of issuance) before enabling the age verification features. Once so enabled, when an account holder seeks to gain access to an age restricted automatic retail device 100, a program resident on the automatic retail device queries the database 222 or server 220 to confirm that the account holder has completed the age verification aspects of the application and that they have been confirmed to be of age for purchase of the products in the automatic retail device 100.

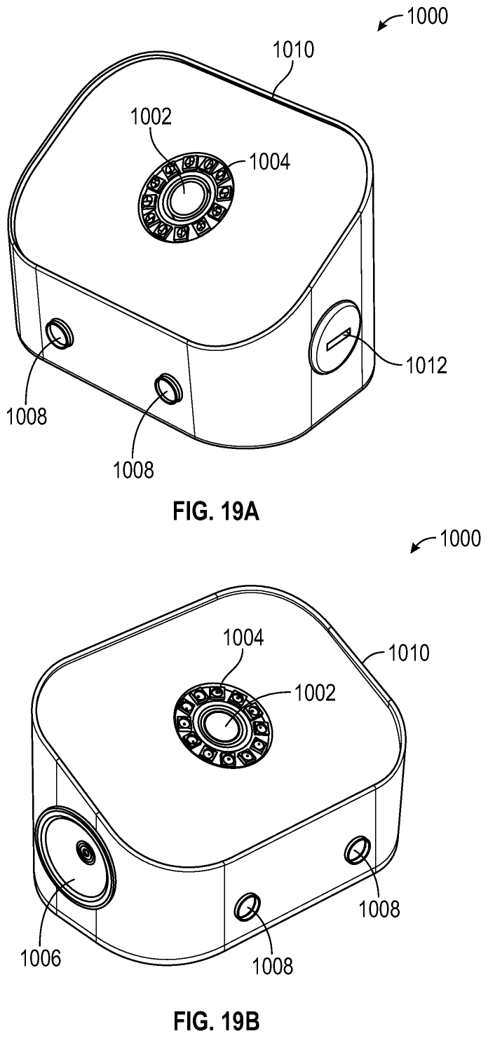

In a similar field of endeavor, FIGS. 19A and 19B depicts a point-of-sale terminal device 100. Like the automatic retail device 100, the point-of-sale terminal device 1000 includes a camera 1002 for capturing images. The camera 1002 may be in proximity of one or more light sources such as the light emitting diodes 1004. The point-of-sale terminal device 1000 also includes a speaker 1006 and at least one microphone 1008. A housing 1010 allows for all these elements to be conveniently packaged together so they can be secured to a point-of-sale terminal via a locking mechanism 1012.

The point-of-sale terminal device 1000 includes a processor and memory storing applications that can be executed by the processor. The point-of-sale terminal device 1000 includes an access device (not shown) for connecting to the internet and particularly to the image recognition fraud and theft detection systems described herein above in connection with the automatic retail device 100. The access device may be, for example, a network interface controller that can connect to the internet via a wired or wireless connection.

In addition to connecting to the fraud and theft detection systems described above, the point-of-sale terminal device 1000 may also be connected to a point-of-sale terminal (e.g., the cash register where the cashier might ring up the items for purchase and take payment from the purchaser (cash, credit card, debit card, Apple Pay, Google Pay, etc.). The connection to the point-of-sale terminal may be wired or wireless and enables communication between the point-of-sale terminal device and the actual point-of-sale terminal. As a result, though described above as having a speaker 1006, the point-of-sale terminal device 1000 may communicate with the cashier in a discrete manner. In an example, the communication may be in the form of text presented on the point-of-sale terminal and other information that can be useful to the cashier or clerk as will be described in greater detail below.

In operation, the camera 1002 works like the camera 124 on the exterior of the automatic retail device 100. The images captured by the camera 1002 are analyzed by a facial recognition software application that employs one or more convolutional neural networks to detect features of an individual that appears in the images. The convolutional neural networks may be resident on the point-of-sale terminal device 1000 or may be connected to the point-of-sale terminal device 1000 via a wired or wireless connection over the internet. As with the facial recognition application for the automatic retail device 100, the facial recognition software for the point-of-sale terminal device 1000 must also verify the quality of the image, once the features are detected and the quality of the image is confirmed, the facial recognition software seeks to find a match to identify the person as they approach the point-of-sale terminal. As with the automatic retail device 100, a database, which may be the same database 222 or server 220 can be accessed to determine whether the image captured by the camera 1002 has the same features as a prior image captured of a person (i.e., that the person has been previously imaged).

The database 222 or server 220 not only stores the image of the person but also other information about the individual appearing in the images. As an example, the point-of-sale terminal device 1000 captures images each time a person presents themselves at a point-of-sale terminal to conduct a transaction. That image may include a date and time stamp and may in fact be a series of images or a video. In addition, the images may be associated with a unique transaction identification number. Also stored with the images may be a record of the items purchased through the point-of-sale terminal. In one example, if the individual who is imaged pays for the goods with a credit or debit card, that information may also be stored and associated with both the transaction and the image. Thus, if a fraudulent card was ever used, that information will be associated with the image as well. As a result, when the database is queried to determine if there is a match to an image acquired at a point-of sale terminal device 1000, if that match identifies the individual as someone who has previously used a stolen or otherwise fraudulent credit card, the point-of-sale terminal device 1000 may present an indicator on the point-of-sale terminal directing the cashier to request a second form of identification from the person imaged if they attempt to pay with a credit or debit card. In this way, the retailer can limit their exposure to fraudulent transactions and limit their losses.

In addition to alerting the cashier regarding the need for a second form of identification additional steps may also be taken including alerting a manager to a potential issue with the customer and potentially alerting the police that an individual associated with a prior fraudulent transaction is seeking to do so again. This action may be taken regardless of whether a currently presented credit card is in fact valid. Just by the past behavior the person may be excluded from further transactions.

As with the automatic retail device 100, mechanisms are available for automatic and manual review of the decision to deny the person the ability to undertake the transaction. Further, the individual may seek the assistance of customer support to correct any improper denial.

In this way the retailers employing point-of-sale terminals and the operators of the automatic retail devices 100 can leverage eachother's transactions to build a robust database that can be queried with the facial recognition software and seek to limit theft and fraud. And the potential fraudulent customer can be denied before they conduct any further credit card fraud.

Still further, the database 222 or server 220 may have access to and receive updates of individuals with relevant criminal records and their images. Thus, when an individual who has previously been convicted of armed robbery is imaged at a point-of-sale terminal device 1000, the image recognition software can confirm the match and the point-of-sale terminal device 1000 may cause a notification to appear on the point-of-sale terminal directing the cashier to proceed cautiously. In some instances, this may include allowing the transaction to proceed without a second form of identification to promote the safety of the cashier.

In accordance with another aspect of the disclosure, the camera 1002 of the point-of-sale terminal device 1000 can capture the traffic, estimated age, and gender, of every person who passes by the point-of-sale terminal device 1000. In addition, this data can be correlated to the items purchased. As a result, analytics around the items being purchased in each store can be generated so that a store operator can understand who is buying which products and at what times, and what portion of the customers are within those general demographics.

Other information can also be collected by capturing images of the cashier with the camera 1002 a determination can be made whether the person operating the register or point-of-sale terminal is on their smartphone and how much time the individual spends on their smartphone. This information can be transmitted to a manager or store operator for further action. Similarly, the microphone 1008 can determine whether the cashier greeted the customer properly. As will be appreciated other performance and behavior traits of the cahier can also be collected. Analyses of items such as average wait time, whether an employee took their break, and how long they too their break can be assessed.

Despite the additional functionality, a primary function of the point-of-sale terminal device 1000 is to implement the fraud and theft mitigation systems that the facial recognition features described in greater detail above in connection with the images acquired by the camera 124 of the automatic retail device 100. Though not described in detail in connection with the point-of-sale terminal device 1000, those of skill in the art will recognize that the methods and components described above in connection with the automatic retail device 100 are equally applicable to the point-of-sale terminal device 1000.

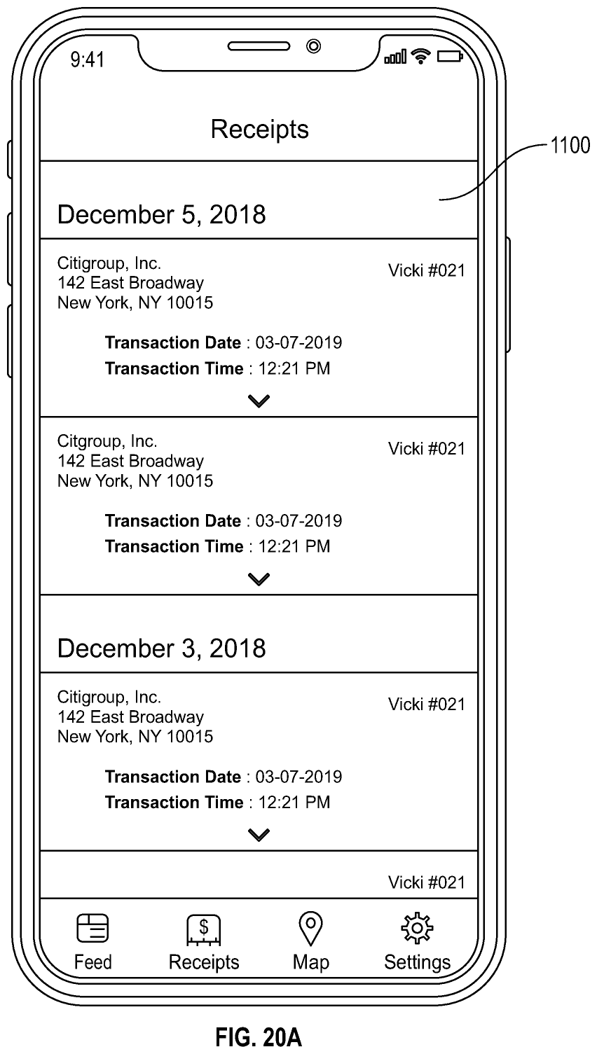

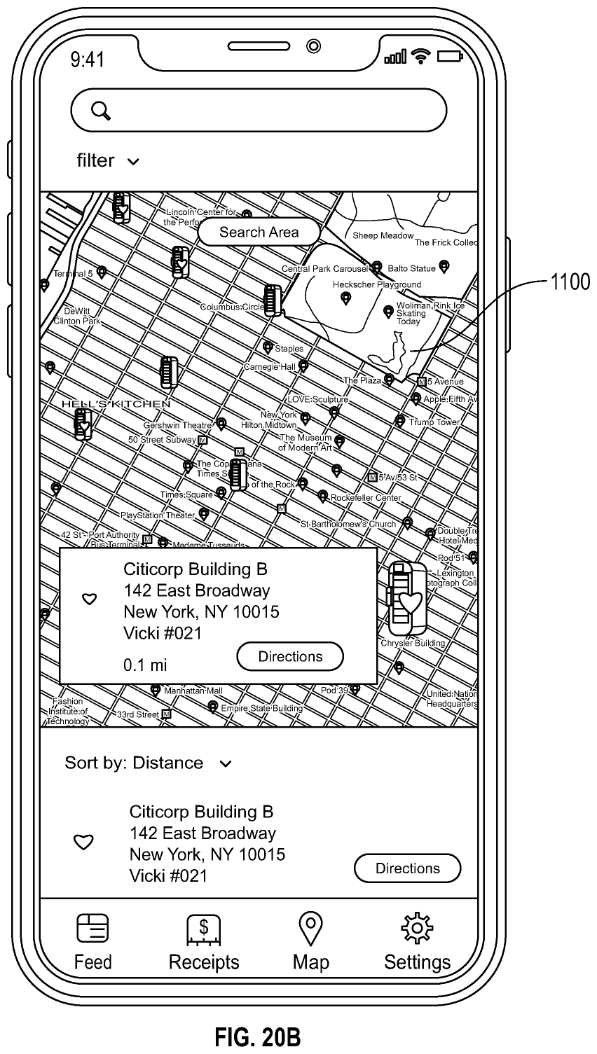

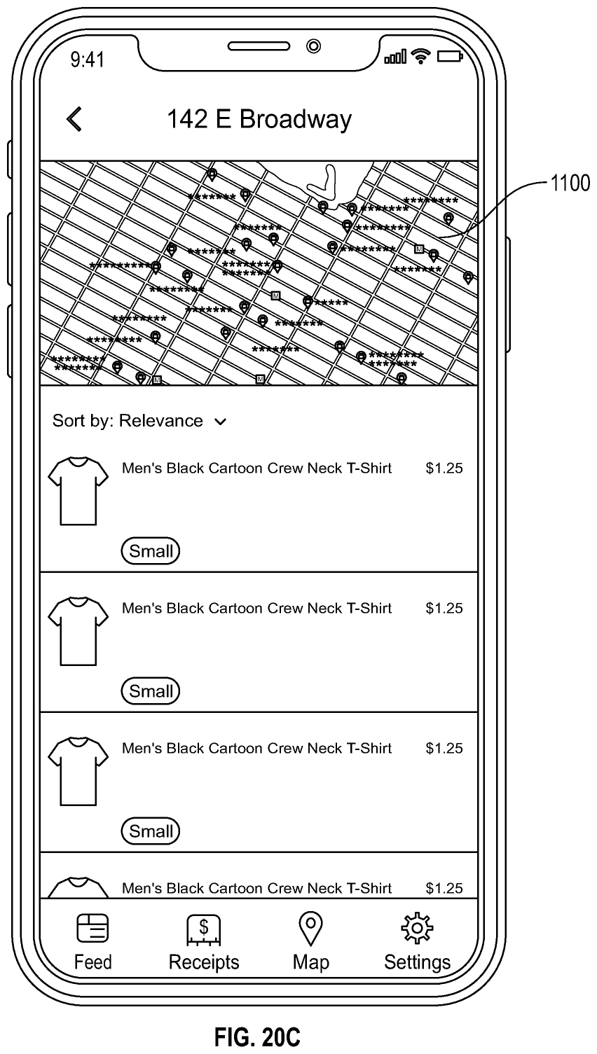

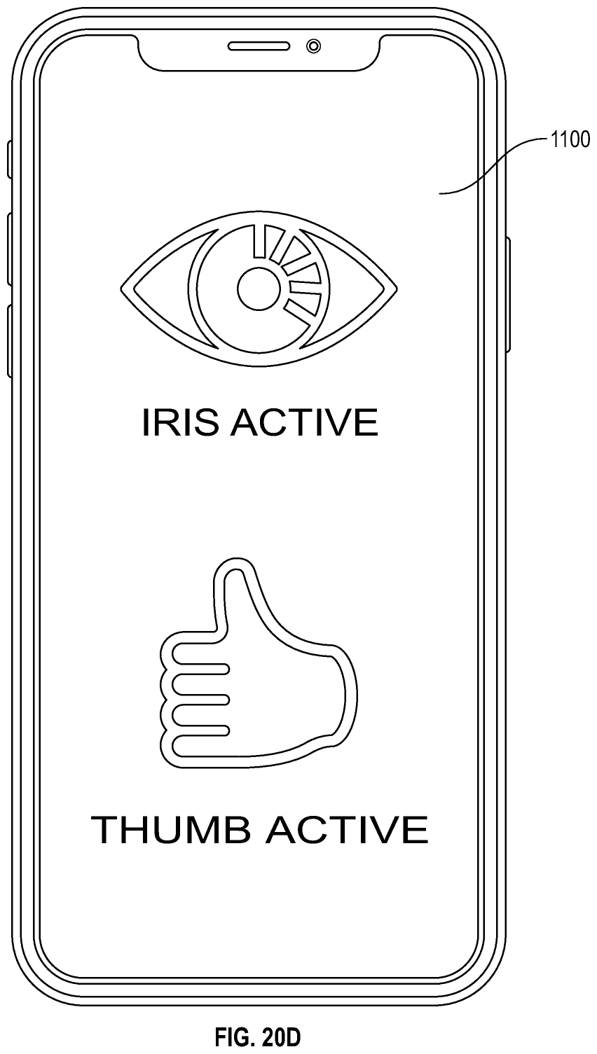

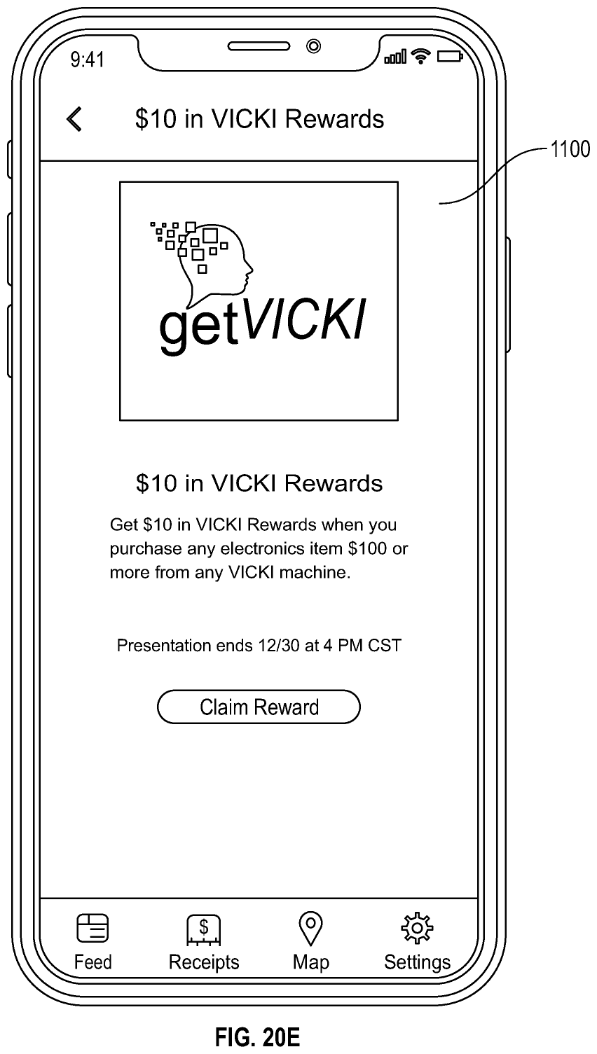

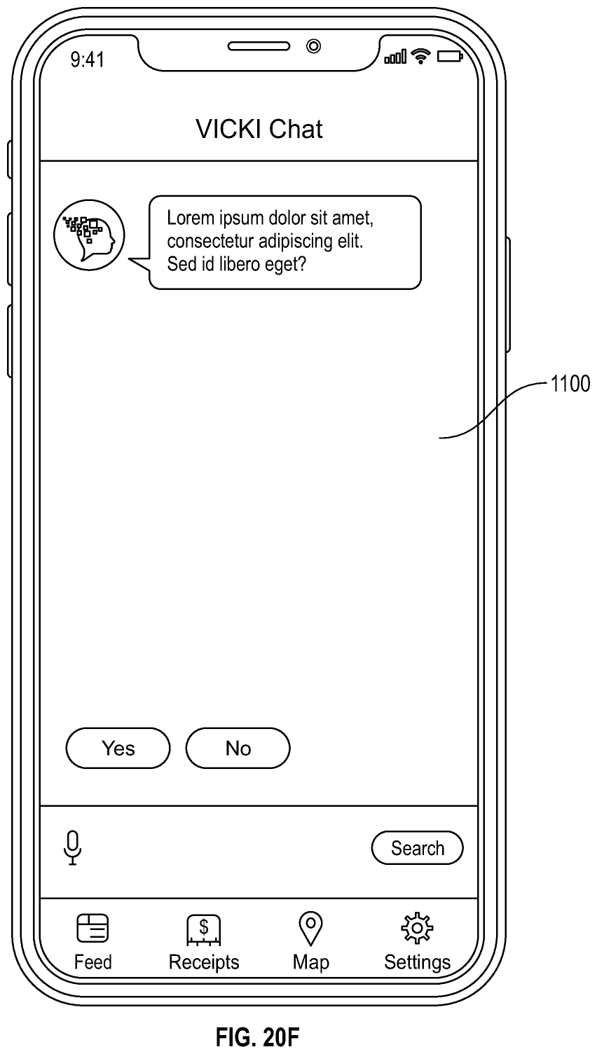

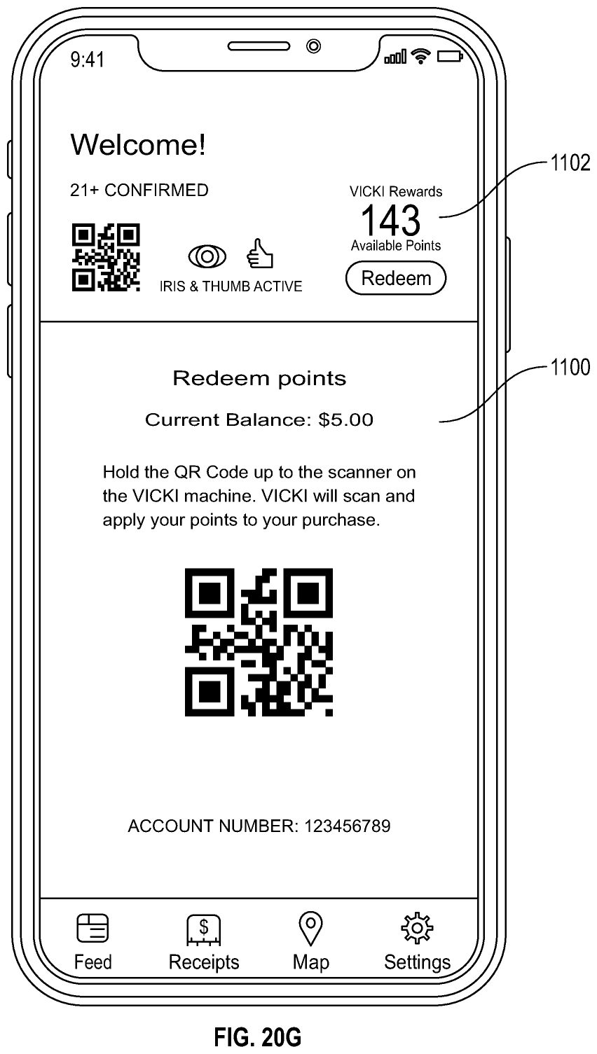

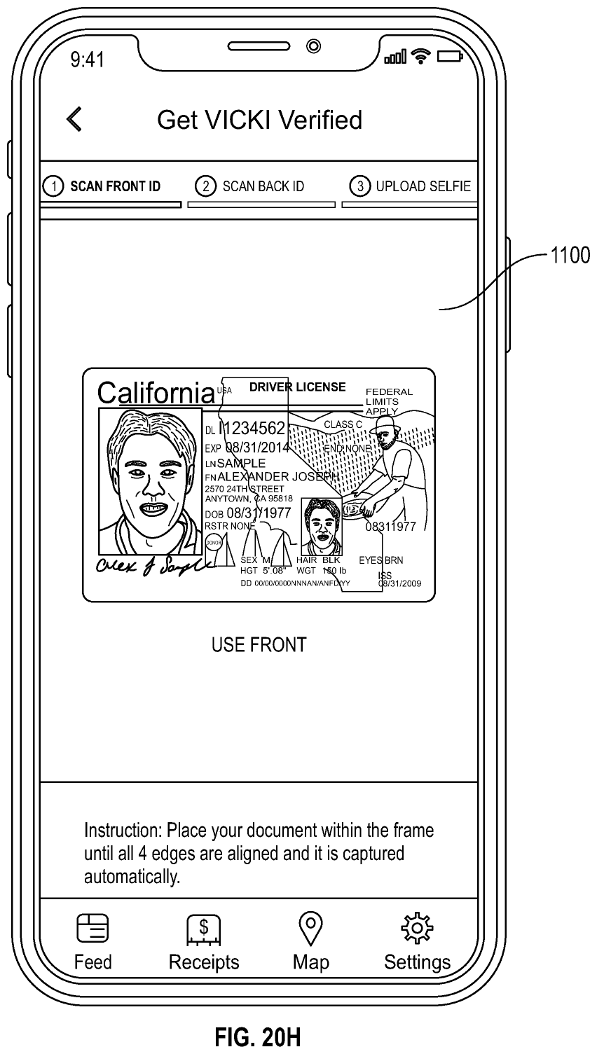

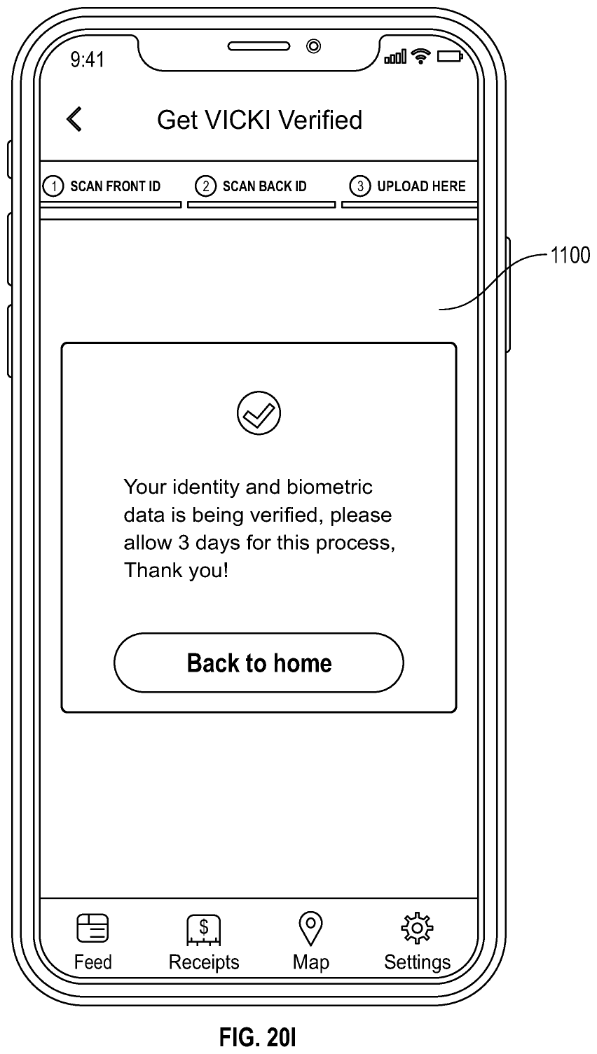

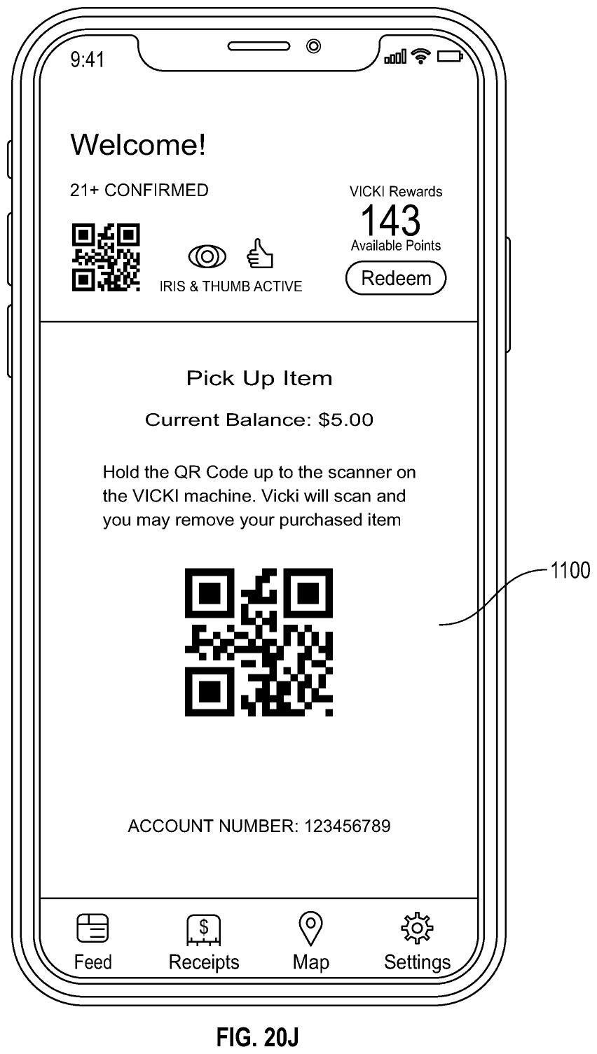

Though the foregoing generally relates to security features of the automatic retail device 100, the disclosure is not so limited. FIGS. 20A-20J depicts a series of screen shots 1100 for aspects of a user application for download and use on a user's smartphone. As noted above, to access the automatic retail device, one option is to become an account holder. Like many other applications after downloading the application from a source, to set up an account requires the input of a variety of information including name, age, email address, phone number, etc. Because account holders are granted access to the automatic retail devices 100, it is necessary to enter some form of payment information. This maybe a credit card number, a bank account from which debits are authorized, a debit card number, a mobile payment system such as Google Pay, Apple Pay, Android Pay, etc. Once sufficient personal data is entered and the payment options are confirmed, the account will become active, and the account holder can now gain access to the automatic retail device 100 to purchase products.

When an authorized user makes a purchase by opening an automatic retail device 100 and removing a product, once the door 102 closes the transaction is complete. Based on the change in weight on the shelves 104 and the products that are detected as removed using cameras 106, 114, and 122 a determination is made regarding which products and how many were removed during the transaction. The application then issues a receipt, as shown in FIG. 20A detailing the transaction including the date, location, time, products removed, price per item, and a transaction total which was charged against the authorized user's credit card or other payment resolution option.

A separate feature in the application can be seen in FIG. 20B, where a mapping function shows the location of automatic retail devices 100. The locations of the automatic retail devices can be searched to find the location of all devices, or as shown in FIG. 20C the location of an automatic retail device 100 having a specific product. For example, FIG. 20C shows the locations of automatic retail devices having the searched for black T-shirt.

As described above, one of the methods that an authorized user may gain access to the automatic retail device is vis biometric data that confirms the individual at the automatic retail device is in fact the authorized user. There are two methods with which the biometric data may be collected. One method of collecting the biometric data is at the automatic retail device 100 itself. A thumb print reader on the outside of the automatic retail device can scan the authorized user's thumb and associate the thumb print with the user's account. Similarly, camera 124 may be employed to scan the user's iris and associate the iris scan with the user's account. Once so associated the authorized user may present themselves at any automatic retail device 100 and gain access by scanning their thumb or their iris. As an alternative, the camera on the user's smartphone and the touchpad on the phone may be employed to capture an image of the user's iris and a thumb print. Once captured, the application can be employed to associate the thumb scan or iris scan with the user's account.

Another feature of the application is that it provides a platform for the presentation of promotional offers such as seen in FIG. 20E. These promotional offers may be from the operator of the automatic retail device 100, from the manufacturers of the products offered for sale in the automatic retail device 100, or from other vendors located near the automatic retail device 100 (e.g., local restaurants, etc.), or vendors having products that might appeal to users of the automatic retail device. As will be appreciated, given the amount of data that is acquired regarding the authorized users and their purchasing habits, these promotional offers can be narrowly tailored to those authorized users likely to execute on the offer. Even the failure to execute on an offer is a datapoint for future promotional offers. This ensures that the vendors are targeting those individuals most likely to purchase a given product or service.

The automatic retail device 100 includes both a microphone and a speaker. The speaker allows an artificial intelligence resident on the automatic retail device 100 to communicate audibly with a person at the automatic retail device. The microphone can detect audible inquiries and responses from the person. The combination allows for the automatic retail device 100 to present a virtual attendant, like what one might expect with a live sales representative, to answer questions and assist in gaining access to the automatic retail device 100, selecting items, and ensuring a smooth process. The automatic retail device 100 may also display promotional or informational videos on a display screen mounted thereto. As an alternative to the communication at the automatic retail device 100, FIG. 20F shows an alternative where a user can engage in a chat with the automatic retail device 100. Using this feature the entire ecosystem of automatic retail devices 100 can be queried to answer questions about locations of items, proximity of automatic retail devices, answer questions about products, or to resolve questions regarding certain charges. All of this may be processed by the artificial intelligence to provide responses. In instances where necessary the chat function may be escalated for resolution by a person, as described herein above.

FIG. 20G depicts another aspect of the disclosure related to a rewards system. By purchasing items from the automatic retail device 100 a user can collect points. The counter 1102 in FIG. 20G shows that 143 points have been earned to date. The application enables the user to redeem these points to pay for products. In one example, by selecting the item for which the points will be redeemed a QR code may be generated. The QR code may be for a free sample of a product, or simply a discount on a product. The QR code can be scanned by a QR code reader on the automatic retail device and the discount applied to the purchase of an item from the automatic retail device. These discounts will appear in the receipts viewable on the screen depicted in FIG. 20A.

FIGS. 20H and 20I depict two related aspects of the application. In FIG. 20H, as described above, with the age verification feature of FIG. 18, the authorized user may upload their government issued identification (e.g., a driver's license or a passport). This second form of identification allows for in-application confirmation that a credit card or other payment resolution means. The authorized user may be asked to capture images of the front and back of the identification as well as an image of them holding the identification, all of which can be stored in the application. As described above, the use of the second form of identification, as is currently done in most retail outlets, helps to eliminate the use of stolen credit cards in undertaking a transaction. Further, and related more to FIG. 20I, the use of the government issued identification allows for the automatic retail device 100 to be used for sales of items that are age restricted. The combination of the biometric data, along with the stored copy of the government identification and the stored payment method enables the of age authorized user to simply present themselves before the automatic retail device 100, have the door 102 automatically open based on the facial recognition features, extract the age restricted item (e.g., beer and wine), have the door 102 automatically close, and be charged for the purchase of the items with no contact to the automatic retail device, or the need to present any additional form of identification or payment at the automatic retail device 100.

Finally, FIG. 20J depicts a further aspect of the disclosure. As an example, referring to FIG. 20C where the location of an automatic retail device 100 containing a specific item was searched, the application also allows for the advance payment of the item which may be a retail item or a food product. When payment is arranged in advance, the application may generate a QR code, that the authorized user then presents at the automatic retail device 100 to resolve payment. In this manner the automatic retail device does not charge the authorized user for the removal of the item, as described above, but rather recognizes the prior payment. Again, the details of this transaction may appear in the receipts shown in FIG. 20A.

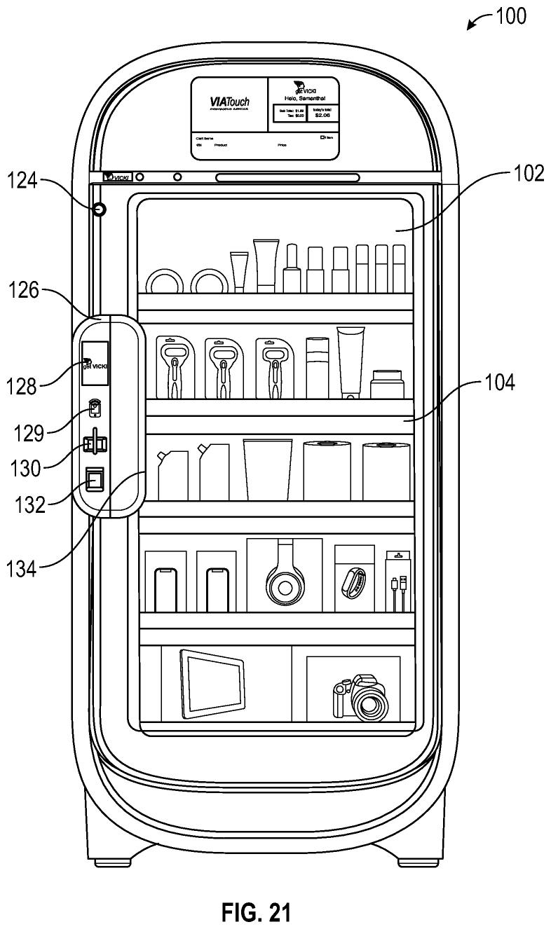

A further aspect of the disclosure can be seen in FIG. 21 showing an exterior view of the automatic retail device 100. The automatic retail device 100 has several safety features related to the recent COVID-19 pandemic. Specifically, the camera 124 is a multi-function camera capable of not only acquiring images for use in facial recognition as described above but also capable of conducting a thermal (e.g., infra-red) scan of a person. The thermal scan capabilities of the camera 124 enable the scanning of the temperature of a person standing in front of the automatic retail device 100. This allows the automatic retail device 100 to determine the whether the person imaged may be experiencing an elevated temperature that might indicate that the person is experiencing the symptoms of an infection. A user that is experiencing an elevated temperature may be denied access to the automatic retail device 100 to protect other shoppers at that location. In addition, the speaker on the automatic retail device may alert the person to their elevated temperature and advise them to seek medical care, and possible to avoid contact with other people until they have sought out the appropriate care.

Additionally, the access panel 126 which includes a touch screen 128, a near field communication (NFC) reader 129, a card reader 130, a thumb print reader 132 and the handle 134 for opening the door 102 includes ultra-violet C (UV-C) lighting embedded in the access panel 126 at strategic locations to apply a UV-C light to those surfaces. UV-C is a known antimicrobial and works by destroying the DNA inside bacteria, viruses, and fungi. Application of UV-C light to surfaces of the access panel 126 that are likely to be touched by a user ensures a safe and clean environment for each user, even if a non-symptomatic individual is allowed to access the automatic retail device.

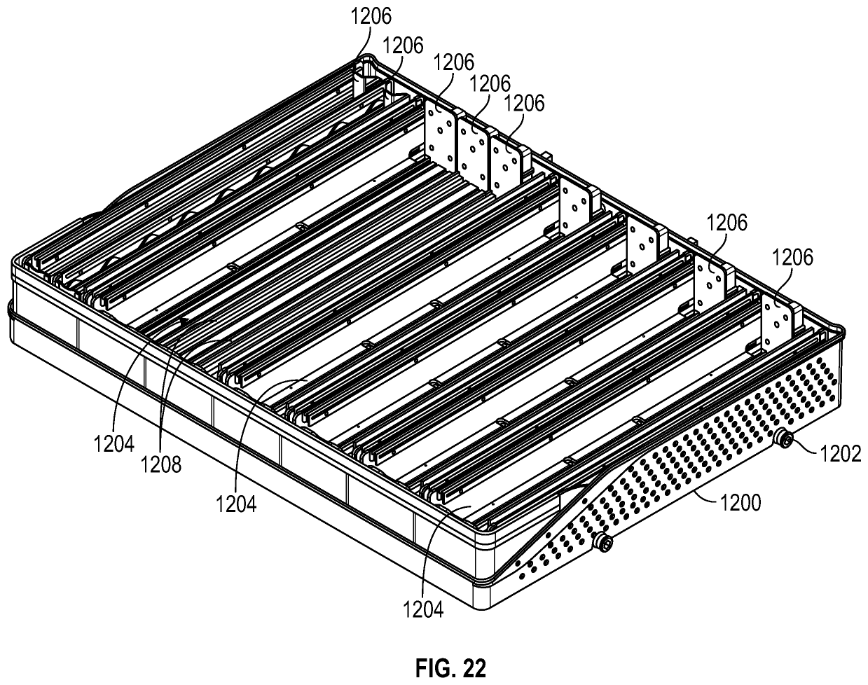

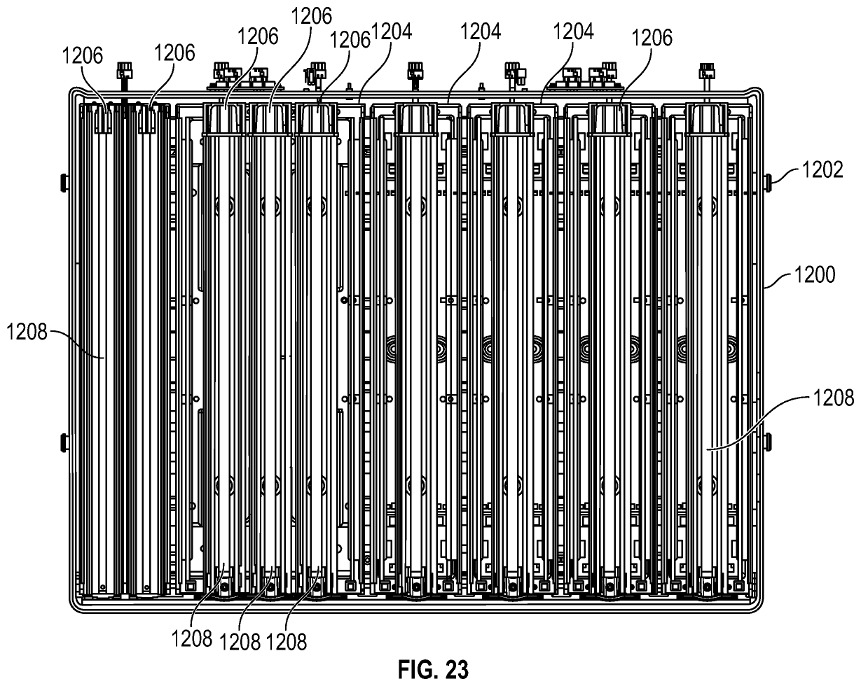

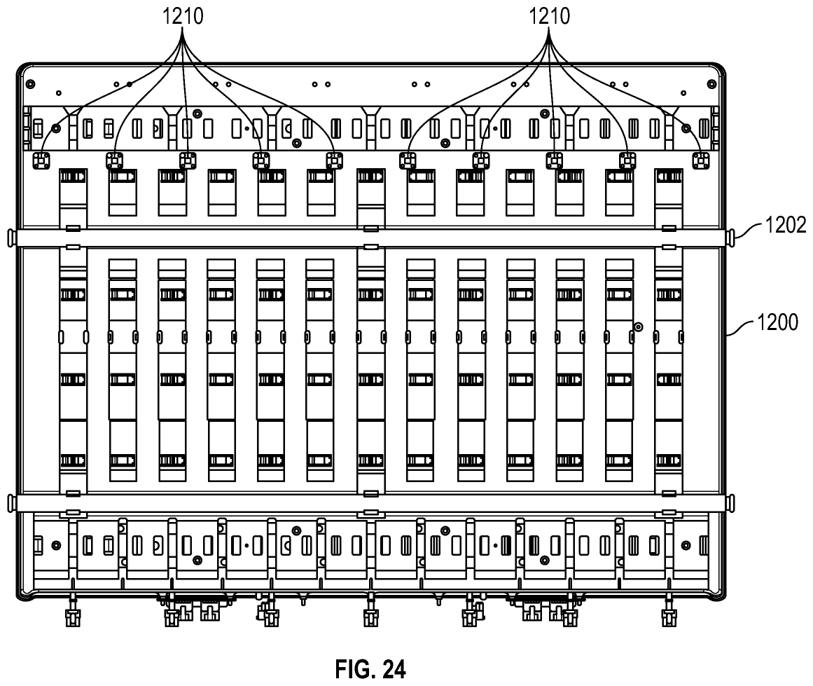

A related safety aspect of the automatic retail device 100 is the use of UV-C lighting inside the enclosure. FIG. 22 depicts one of the shelves 104 that is placed within the enclosure of the automatic retail device 100. The shelf 104 is comprised of several components and is very customizable so that a variety of different products can be sold through the automatic retail device 100. The shelf 104 is formed of a tray 1200. Support bars 1202 extend across a bottom surface of the tray 1200 and extend slightly beyond the end of the tray 1200. The support bars 1202 are received in openings formed in the interior of the automatic retail device 100 and support the tray 1200.

Each shelf 104 is configured to receive one or more bins 1204. The bins 1204 are of different sizes depending on the size of the products to be sold in each bin 1204. Load cells or weight sensors (not shown) are configured under each bin 1204 to detect changes in weight in each bin 1204 as products are removed. This weight change in combination with the imaging described above ensures accurate determination of the products removed from the automatic retail device 100. The load cells are preferable removable and configurable on the shelf 104 or on the bottom of a bin 1204 depending on the product being sold in a particular bin. As will be appreciated, the load cells are in electrical communication with the computing device 202.

Each bin 1204 includes at least one spring driven pusher 1206. The pushers 1206 may be ganged together for a given bin 1204 to move larger or heavier products. Alternatively, the pushers may be sized for smaller products of which there may be larger numbers. As one example, a single pusher 1206 may be sized to receive cans of soda or bags of potato chips. A multiple pusher 1206 bin 1204 may include two or three pushers 1206 to effectively push an item in a larger box or having a greater weight, for example a Bluetooth speaker or other electronic device. Alternatively, the smaller pushers 1206 may be sized to advance smaller items such as lip stick, nail polish, and other smaller sized items. As will be appreciated the spring for driving the pusher 1206, which may be a coil spring that uncoils to advance the pusher 1206, may be sized in differing spring strengths so that it is strong enough to advance all the products remaining in a bin when one is removed, yet also does not crush the products.

The pusher 1206 rides on a track 1208. The track 1208 may be for example a T-track or another shape and mates with bearing (not shown) formed on the bottom or the pusher 1206 to secure the pusher to the track 1208 in the bin 1204 and allow the pusher 1206 to freely move along the track 1208. The bearing may be formed of an acetal Homopolymer, a hard plastic, or a high-density poly Ethelene. The bearing may be shaped to receive the track 1208 and slide along the track 1208 or may be shaped as rollers to roll along the track 1208. The track 1208 may be coated (e.g., powder coated) to substantially eliminate friction between the bearing and the track 1208. The combination of the materials of the bearing and the powder coating of the track 1208 results in a form of linear bearing for the pusher 1206 to traverse as it is advancing products in the bin 1204.

As will be appreciated, in instances where two or more pushers 1206 are to be employed for a given product, this will necessarily require two or more tracks 1208 and the related bearings. In addition, the number and spacing of the shelves 104 within the enclosure of the automatic retail device is also configurable. Thus, where a tall product is to be placed in a bin 1204, the shelf 104 above that tall item may be spaced to accommodate the size and shape of the product. As can be seen with reference to FIG. 21, the spacing between the shelves 104 is not uniform, nor are the number of products per shelf. In this way the product offerings in each automatic retail device 100 is entirely customizable, further, the planogram (i.e., the location of those items in the automatic retail device 100) is also completely customizable to maximize products, enhance visibility, and promote the sale of products.

With reference to FIG. 24 which shows a bottom view of the shelf 104, a plurality of the UV-C lamps 1210 are shown. The UV-C lamps 1210 are formed proximate the front of the shelf 104 and may be angled such that the UV-C light is directed towards the back of the enclosure of the automatic retail device 100. As with the UV-C lamps embedded in the access panel 126, the illumination of the enclosure of the automatic retail device 100 has an anti-microbial effect killing any pathogens that may have found their way within the automatic retail device 100 when the door 102 is opened. In this way users of the automatic retail device can have confidence that they are protected from the spread of pathogens including COVID-19 when interacting with the automatic retail device.

In one aspect of the disclosure, the UV-C lamps 1210 are triggered following the closure and locking of the door 102 of the automatic retail device 100. Between the angle at which the UV-C lamps are placed at and the glass of the door 102 (through which the UV-C light does not pass) users and passersby of the automatic retail device 100 are generally protected from exposure to the UV-C light. The UV-C light kills 99% of the pathogens in the automatic retail device 100.

Though described elsewhere herein, another aspect of the disclosure is directed to the use of QR codes. In one aspect of the disclosure, dynamic QR codes may be displayed on a display screen 128 on the automatic retail device 100. The QR code, when displayed can be scanned with a user's smartphone operating an application as described above. Where the person scanning the QR code is an authorized user, the interconnection between the application and the automatic retail device 100 results in a communication that authorizes the door 102 to open. This may be particularly useful where a user does not want to use the thumbprint biometric code and to engage in a contactless transaction.

Following scanning of the QR code, opening of the automatic retail device 100, and subsequent closure, a new QR code generated and displayed on the display screen 128 ready for the next person approaching the automatic retail device 100. By dynamically generating the QR codes and making the codes one-time use or very limited use, spoofing of the QR codes becomes near too impossible.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules associated with, for example, a medical device.

In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

We claim:

1. An automatic retail device comprising:
a housing including an enclosure having a plurality of shelves mounted in the enclosure, and a door providing access to the enclosure when open and preventing access to the enclosure when closed;
a first camera mounted along a top portion of the enclosure and configured to capture images in a top-down manner;
a second camera mounted on a side of the enclosure and configured to capture images from of the automatic retail device; and
an application stored in a memory and executed by a processor, wherein the application when executed by the processor:
detect a presence of a user's hands in the images generated by the first and second camera;
detect a presence of a product in the user's hands in the images generated by the first and second camera;
determines a identity and number or products removed from the automatic retail device; and
charges the user based on the identity and number of products removed from the automatic retail device.

2. The automatic retail device of claim 1, wherein the application employs a first convolutional neural network to identify the user's hands and a second convolution neural network to identify a product in the user's hands.

3. The automatic retail device of claim 2, wherein the second convolutional neural network analyses a subregion of the image in which the hands are detected.

4. The automatic retail device of claim 3, further comprising a third convolution neural network configured to determine the identity of the product detected in the user's hands.

5. The automatic retail device of claim 4, wherein the application is configured to track the user's hands in the images from the first and second cameras and detect suspicious movements of the user's hands.

6. The automatic retail device of claim 5, further comprising a fourth convolutional neural network to detect suspicious movement of the user's hands.

7. The automatic retail device of claim 1, further comprising weight sensor associated with each of the shelves, wherein the weight sensor is configured to detect the removal or return of a product to or from one of the plurality of shelves.

8. The automatic retail device of claim 7, further comprising a planogram is stored in the memory, the planogram identifying the identity and.

9. The automatic retail device of claim of claim 8, wherein the application determines the identity and number of products removed from the automatic retail device based on the images from the first and second cameras, the identification of a product in the user's hands, and a change in weight on the shelf.

10. The automatic retail device of claim 1, further comprising a third camera on an interior surface of the door.

11. The automatic retail device of claim 10, wherein the application is configured to acquire an image from the third camera, the image including the plurality of shelves and any products on the plurality of shelves.

12. The automatic retail device of claim 11, wherein the application identifies the products located on the shelves in the images generated by the third camera.

13. The automatic retail device of claim 12, wherein the application identifies portions of the plurality of shelves having no products.

14. The automatic retail device of claim 1 further comprising an automatic door opener, and configured to open the door without requiring contact from a user.

15. The automatic retail device of claim 14, further comprising a display screen depicting a QR code for scanning by a user's smartphone, wherein an application on the user's smartphone is in communication with the automatic retail device.

16. The automatic retail device of claim 1, further comprising a fourth camera on an exterior of the automatic retail device and configured to capture images of an area in proximity to the automatic retail device.

17. The automatic retail device of claim 16, wherein the application analyzes images captured by the fourth camera to detect an identity of a person captured in the image is an authorized user.

18. The automatic retail device of claim 17, wherein if the person captured in the image is an authorized user, the application unlocks the door.

19. The automatic retail device of claim 17, wherein if the person captured in the image has previously committed credit card fraud or theft at an automatic retail device access to the automatic retail device is denied.

20. The automatic retail device of claim 19, further comprising a convolution neural network to analyze the images acquired to identify the person captured in the image.
